(19) United States
(12) Patent Application Publication
(10) Pub. No.: US 2026/0359151 A1
(43) Pub. Date: Nov. 12, 2026

(54) AI-BASED API AND CONTENT DISCOVERY, UNDERSTANDING AND INTERACTION ORCHESTRATION PLATFORM

(71) Applicant: Pythius Labs LLC, Peachtree City, GA (US)

(72) Inventors: Thomas Samuel ELLIS, III, McDonough, GA (US); Jeremy Matthew MORRIS, Dunwoody, GA (US)

(73) Assignee: Pythius Labs LLC, Peachtree City, GA (US)

(21) Appl. No.: 19/692,957

(22) Filed: May 29, 2026

Related U.S. Application Data
(63) Continuation of application No. PCT/US2024/057888, filed on Nov. 27, 2024.
(60) Provisional application No. 63/603,971, filed on Nov. 29, 2023.
(60) Provisional application No. 63/617,036, filed on Jan. 2, 2024.

(51) Int. Cl. G06F 9/54

(52) U.S. Cl. CPC G06F 9/547

(57) ABSTRACT

A method, computer program product, and computer system for using an API to respond to a user input. An API orchestration platform may search for at least one API endpoint for performing a task. In response, the platform may retrieve API information for the endpoint. The platform may cause an AI model to analyze the information to generate structured API contextual information for the endpoint, which may be stored. The platform may receive the user input from a user device. The platform may determine a set of API endpoints that match the user input based on corresponding structured contextual information for each endpoint. The platform may generate a set of API calls using the contextual information. The platform may transmit the calls to the endpoints. The platform may receive responses from the endpoints. The platform may transmit a response to the user input based on responses received from the endpoints.

### RELATED CASES

This application is a continuation of International Patent Application No. PCT/US2024/057888, filed on 27 Nov. 2024, which claims the benefit of U.S. Provisional Application Serial No. 63/617,036, filed on 02 Jan. 2024, and claims the benefit of U.S. Provisional Application Serial No. 63/603,971, filed on 29 Nov. 2023, the disclosures of which are all incorporated herein by reference in their entireties.

### FIELD

The present disclosure relates to chat applications that leverage AI models such as large language models to assist users in finding and interacting with relevant data and functionalities located at external data sources or applications and/or within multimedia/audio/video/text files.

### BACKGROUND

Large language models and other AI models have created new computing capabilities. Large language models are designed to make predictions using massive amounts of natural language text, videos, images and other media as historical data to predict the most likely responses to a question.

### BRIEF DESCRIPTION OF THE DRAWINGS

The accompanying drawings, which are included to provide a better understanding of the disclosure, illustrate embodiment(s) of the disclosure and together with the description serve to explain the principle of the disclosure. In the drawings:

FIG. 1 is a system diagram illustrating a platform for implementing the functions described herein.

FIGS. 2A-2C are a diagram illustrating an example API-Connected chat application.

FIGS. 3A-3C are a diagram illustrating an example pre-interaction/ongoing phase of the API-connected chat application.

FIGS. 4A-B are methods of analyzing API information to prepare APIs for use with the API-connected chat application.

FIG. 5 is a diagram illustrating an example user onboarding flow for the API-connected chat application.

FIGS. 6A-6B are a diagram illustrating an example user query processing flow for the API-connected chat application.

FIG. 7 is a diagram illustrating an example data structure for storing recipe data for the API-connected chat application.

FIG. 8 is a method of processing a user query and executing API calls based on the user query for the API-connected chat application.

FIGS. 9A-9C are example user interfaces for the API-connected chat application.

FIG. 10 is a diagram illustrating an example multimedia knowledge base application.

### DETAILED DESCRIPTION

### API-Connected Chat Application

### Overview

Disclosed herein is a platform that leverages LLMs and other types of generative and/or AI models and that adds the ability for LLMs or other models to real-time learn and interact with any (and across multiple) applications that have API layers, thereby bridging the gap between AI/LLMs and real-world applications without any coding, tool installs or custom configuration needed by the user. Intelligently stringing API calls together, the platform allows users to give it complex, cross-application tasks in response to user requests.

An API-connected chat application is described for connecting user requests with various data sources and/or applications available via APIs or other communication mechanisms. The application described herein enables users to use natural language to interact with real world applications through their APIs. The application described herein may integrate advanced Large Language Models (LLMs) that enable users to interact with various external applications via any available APIs (e.g., open APIs, partner APIs, internal APIs, composite APIs, etc.) using natural language processing in “real time” to complete a user request. The application therefore bypasses the need for users to have an understanding of the complex programming that may typically be required for advanced interaction with external applications and APIs. Several advanced use cases that illustrate the functionality of the application are described in more detail below.

The application described herein may be configured to parse and analyze API endpoints and to onboard the API endpoints so that users may interact with them. In embodiments, the application may use API routes for rapid data transfer, may incorporate an LLM to enhance language processing, and may analyze API endpoint data to infer anticipated API functionality as well as to confirm, test, and/or establish a comprehensive set of capabilities that users can initiate through natural language processing. In some embodiments, the application transmits search requests to search platforms (e.g., SERPAPI™, SERPER ™) and receives pertinent data therefrom, which may be stored and/or provided to users.

In embodiments, the application may be deployed as a cloud-based system/platform to increase scalability and performance. For example, the system/platform may be configured to handle multiple operations simultaneously using a modular and/or scalable design that is capable of implementing the various functions described in more detail below. The platform may leverage various backend frameworks that provide tools and libraries to develop, test, and/or deploy the various modules described herein.

The platform may store data using any data storage technology that ensures data integrity, security, and efficient accessibility. In embodiments, the platform may leverage a Database Management System (DBMS) that is configured to efficiently store, retrieve, define, and/or manage data in a database, thereby maintaining data consistency, reducing redundancy, and ensuring quick data retrieval. Moreover, the platform may use security measures to protect the stored data from unauthorized access and breaches. In embodiments, the platform’s databases may store data embeddings in a vector space, which may enhance the platform’s ability to understand and retrieve information based on measures of contextual similarity.

The platform may configure API routes that effectively direct and manage tasks and queries, as described in more detail below. Configuring the routes may include leveraging API management tools that assist in designing, deploying, and managing the API routes.

The platform may provide real-time data processing using real-time processing engines configured to handle and process data as the data is received, thereby providing faster feedback to users. In embodiments, the processing engines further analyze and/or provide reports concerning various data in real-time.

In some embodiments, the platform employs an AI-driven search agent to search and/or navigate the internet and identify potential data sources (e.g., API endpoints). The platform may include advanced web scraping tools that may be used to extract data from the data sources, transform the data, and/or integrate the data into the system.

In embodiments, the platform may regularly update its data sources in order to continually onboard new data sources and/or to keep up to date with API changes or the like. The platform may also continuously improve one or more models (e.g., LLMs) that are used to implement various functions of the platform, thereby steadily increasing the capability and functionality of the system.

In embodiments, the platform may leverage the capability of LLMs for understanding the context of user commands, and may use this knowledge to retrieve external information (e.g., via APIs) and/or otherwise make the functionalities of various external applications accessible to users via their APIs. For example, the platform may allow users to communicate with the platform using plain English (or other languages), while understanding the context of user requests and remembering past interactions. The platform may inject relevant information into user conversations and/or perform actions based on user queries. The platform may provide a user-friendly interface that provides these functionalities together with easy navigation through and interaction with the information provided by the platform. In embodiments, the user interface may be a chatbot interface that facilitates natural conversations via text, audio, or other media.

In embodiments, the platform may be continuously improved based on user interaction and feedback. For example, the platform may monitor anomalies and update various components to maintain connectivity with external applications. Moreover, the platform may securely and privately store user interactions, which may be used to improve user experiences through personalizing responses and/or fine-tuning.

### System Overview

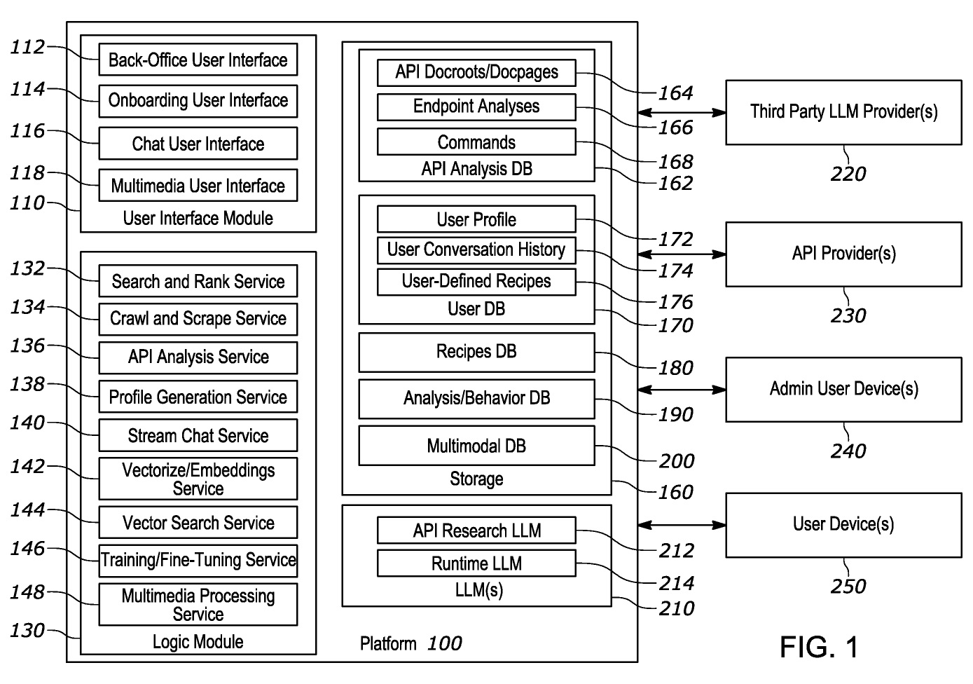

FIG. 1 illustrates a platform 100 for implementing the functions described herein, including various components of the platform 100, and various other devices in communication with the platform 100. The platform 100 may include a user interface module 110 that is configured to generate a plurality of user interfaces and/or user interface data for admin user devices 240 and/or user devices 250, among other devices. In embodiments, the user interfaces may be implemented server-side, client-side, or both, and may be implemented via web applications, native applications, mobile applications, and/or may be any other type of user interface. The functions of the various user interfaces are described in more detail below.

The platform 100 further includes a logic module 130 for implementing the non-AI functions of the platform as described herein. For example, the various functions may be implemented by a plurality of services, which may be individual microservices and/or may be combined according to various other architectures.

The platform 100 further includes storage 160, which may include an API analysis database 162 for storing API information, a user database 170 for storing user information, a recipes database 180 for storing API recipes, an analysis/behavior database 190 for storing query data, fine-tuning data, and/or other data, and a multimodal database 200 for storing videos and other multimedia files, transcripts thereof, and the like.

In some embodiments, the platform 100 may implement local LLMs 210, including an API research LLM 212 for analyzing APIs provided by API providers 230, generating contextual data for the APIs, and storing the contextual data in an API analysis database 162. Additionally or alternatively, the platform 100 may include a runtime LLM 214 for interacting with users, responding to user messages, processing data from APIs for users and/or for submission to other APIs, and/or the like. In some cases, the platform 100 may implement a single local LLM that may carry out the functions of the LLMs 212 and 214. It should be noted that, although the disclosure herein frequently refers to LLMs, other types of language models or other AI models may be capable of performing the functions ascribed to the LLMs herein, and these other models are considered to be within the scope of the disclosure.

In embodiments, the platform 100 may use LLM(s) provided by third party LLM providers 220 instead of or in addition to local LLMs 210. In these embodiments, the platform 100 may not use any local LLMs, may use local LLMs only as a backup (e.g., when third party LLM providers 220 are not available), may use local LLMs for some functions and third party LLMs for other functions, and/or the like. Accordingly, it should be understood that any function attributed to an LLM as described herein may be performed by the platform 100 and/or by a third-party service.

The platform 100 may communicate (e.g., via a network interface and any available communication networks) with various devices including third party LLM providers 220, API providers 230, admin user devices 240, and/or user devices 250 as described in more detail below.

### Example Methods and Flows

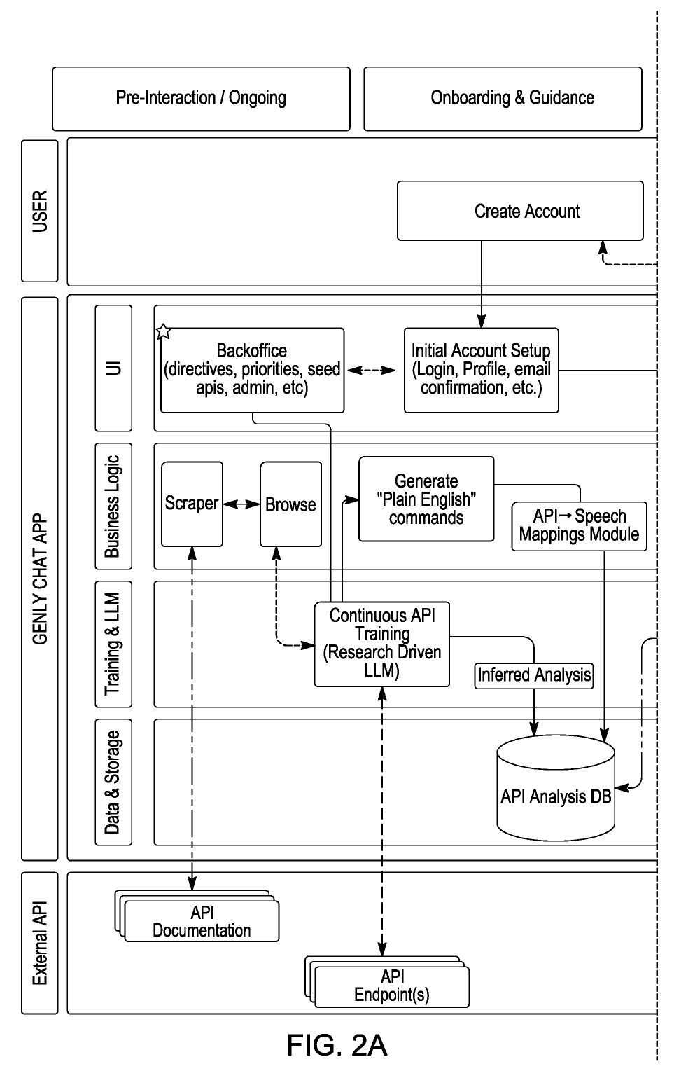

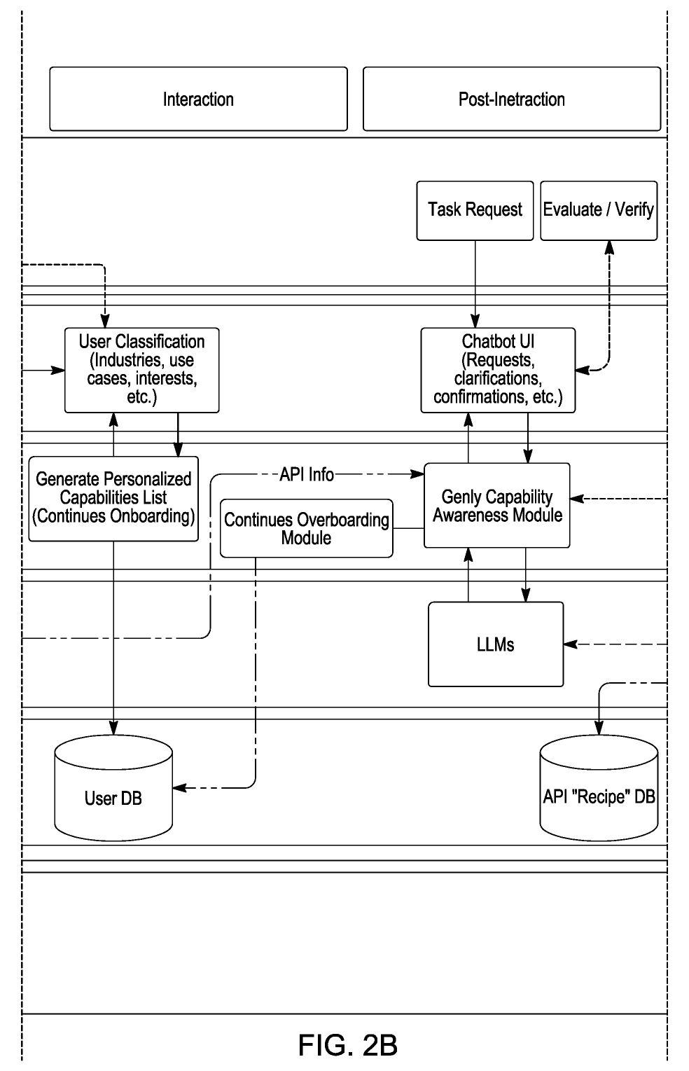

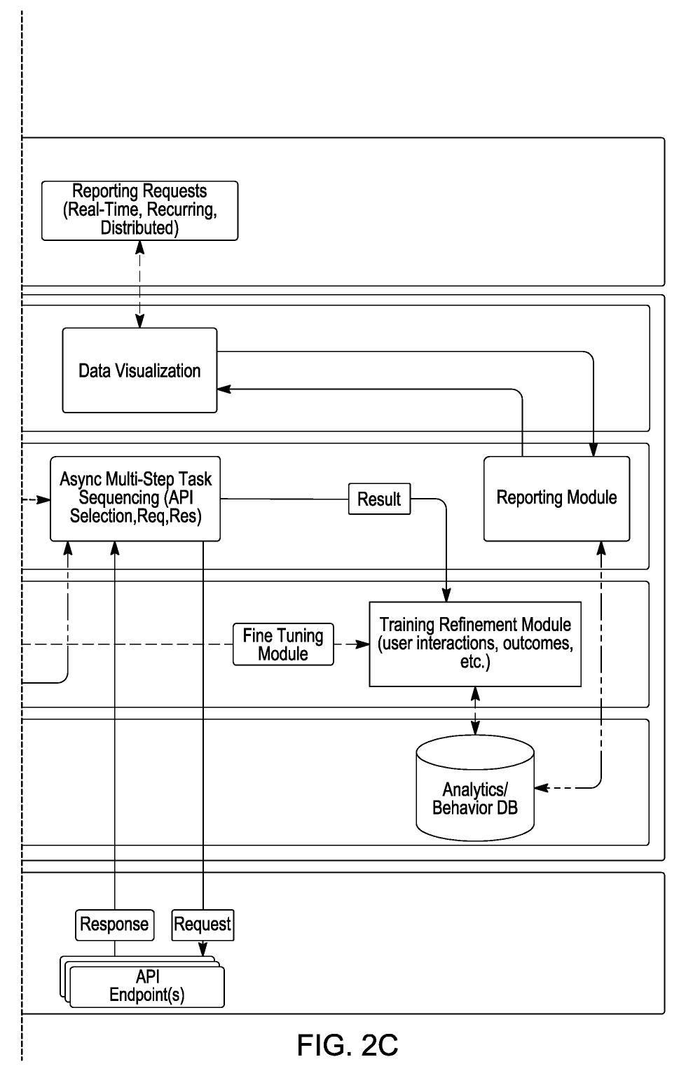

FIG. 2 (i.e., FIGS. 2A-2C combined) illustrates a diagram for the application (labelled “Genly Chat App” in the diagram) implemented on the platform, which operates as an intermediary between a user and external APIs, utilizing a large language model (LLM) or other generative AI model to receive user queries and subsequently fetch data from various external APIs, which may be used by the LLM and/or returned to the user according to the user’s requests.

FIG. 2 (i.e., FIGS. 2A-2C combined) shows that various functions may be divided into three layers: a user layer (e.g., at a user device 250), an application layer (e.g., at platform 100), and an external API layer (which may include components run locally and/or at external API provider(s) 230). The application layer may be divided into four sub- layers: the user interface (UI) (which may be implemented by the user interface module 110), business logic (which may be implemented by the logic module 130), training and LLM (which may be implemented by LLMs 210 and/or third party LLM providers 220), and data and storage (which may be implemented by storage 160). Different components may implement the functions/modules shown in the various layers and sub-layers.

FIG. 2 illustrates a pre-interaction/ongoing phase that details the system’s continuous learning and adaptation capability, where the system may scrape, analyze, and store data from various API documentations and endpoints. This data may then be used at run time in order to provide user-friendly interactions with APIs. The pre-interaction / ongoing phase thus keeps the application up-to-date with the latest API changes and/or may be used to continually add new APIs to increase the functionality of the application.

The application may include business logic (e.g., a crawl and scrape service 134) that may be configured to find, analyze, and integrate various Application Programming Interfaces (APIs). This configuration process may involve navigating the web to locate data sources, understanding the context of the data sources, and gathering pertinent data about the data sources. The configuration process may further include gathering and parsing documentation about each API, as well as testing interactions with each API prior to integrating data, executing search requests via the APIs, and retrieving relevant information.

The logic module 130 may be configured to search for and scrape API documentation from various external APIs (e.g., as illustrated by the arrow between the scraper and the API documentation boxes). The API documentation may be available at web pages maintained by the external API providers, which may be scraped by the scraper module. For example, the web pages may describe the type of API (e.g., RESTful), various API endpoints, associated request parameters, response format, etc. The scraper module may use various scraping tools (e.g., CHEERIO™, PUPPETEER™, PLAYWRIGHT™, etc.).

A crawl service and/or API analysis service 136 may be involved in browsing, parsing, examining, and/or analyzing the scraped API documentation (or other materials available via the API) for relevant data. For example, the crawl service may parse the scraped web pages to extract meaningful information, such as available API endpoints, the required parameters for each endpoint, the expected response format, etc. In embodiments, the crawl service may be configured to transform the data to match a standard schema, which may involve data cleansing, format conversion, validation, and/or the like. In some embodiments, the standard schema may account for variations in documentation formats.

In embodiments, the search and rank service 132 and/or crawl and scrape service 134 may be configured to handle both private (e.g., enterprise) and public APIs for various use cases. For private/enterprise APIs, the services may be configured to access API documentation via a secure connection (e.g., if the documentation is hosted in a private network or behind authentication layers). Accordingly, the services may be configured to use appropriate credentials or access rights to fetch documentation from a private server (e.g., via standards such as Oauth for secure, token-based access to API documentation).

For public APIs, the services may be configured to fetch the API documentation directly from public-facing URLs that host the documentation. These may be official websites of the API endpoint services and/or other platforms that host API documentation (e.g., Swagger, Postman, or GitHub). In embodiments, the scraper may be configured to understand the structure of various platforms to more efficiently retrieve, parse, and/or format the information.

In embodiments, the services may be configured to handle different API documentation formats. For example, some API endpoints may provide documentation in the form of web pages, while others may use structured formats like OpenAPI or RAML. The services may be configured to parse these different formats and extract information from them.

Additionally, API endpoints may be different types like REST, SOAP, GraphQL, etc., which may have different ways of structuring requests and responses. Accordingly, the services may be configured to handle and understand different types of APIs. As examples, the scrape and/or analysis services may be configured to parse and understand a WSDL document provided by a SOAP API, a JSON response from a REST API, and/or the like.

The services may be configured to feed parsed/structured information to a continuous API training service (e.g., API analysis service 136) for processing. This service may be configured to analyze the data scraped and browsed from the API documentation and data received from other sources and to update stored knowledge about APIs.

In embodiments, a back-office user interface 112 may provide a user interface for receiving configuration information, such as directives, priorities, seed APIs, various admin information, and/or the like. For example, an administrator user may provide information for configuring the various business logic modules, user interface modules, LLMs, data and storage, and/or the like. This information may include a list of seed APIs that will be ingested via the scrape/browse module and/or the continuous API training module, data providing context to the LLM for various use cases (e.g., custom prompts for various LLM use cases as described herein), fine-tuning data, algorithms and/or configuration data that may be used by the modules to perform any of the functions described herein, and the like. In embodiments, directive information may be received by the user interface and used to begin an API onboarding process, such as by searching to find a matching URL, crawling and scraping the entire URL, and storing the scraped data (e.g., clean HTML) in the API analysis database 162. The data in the API analysis database may be queued and analyzed by the LLM as described in more detail below.

In embodiments, the continuous API training service may connect to the various API endpoints of the one or more external APIs provided by third party LLM providers 220. In these embodiments, the continuous API training process may involve interacting with actual API endpoints to gather more data or context (e.g., by conducting initial tests on selected API endpoints to understand their structure, response patterns, and/or data types). For example, the continuous API training service may issue a request to an API endpoint and analyze the response to understand what kind of data the endpoint provides. This contextual information about endpoint(s) may be stored in the API analysis database 162 for future reference. For example, if the continuous API training discovers that an API endpoint returns data in a specific format, it may store this information in the database. The stored information allows the application to understand how to interpret the data returned by the endpoint when an LLM calls the API (e.g., in response to a user query). In embodiments, the continuous API training service may issue several calls to an API and analyze the various responses for discrepancies or irregularities, which it may store and/or analyze as contextual data.

In embodiments, the continuous API training service may analyze API endpoints without reference to any documentation, thereby inferring the structure and usage of the API endpoint based on the responses that are returned. The continuous API training service may generate a confidence score that is lower for an inferred analysis but is raised over time as the documentation is analyzed and/or additional usage data for the API is collected. Additionally or alternatively, the continuous API training service may analyze the API endpoints with reference to documentation, thereby resulting in a higher confidence score.

In embodiments, the continuous API training service may use an LLM to generate summary data about a particular API, which may be used at runtime to assist in selecting a particular API to fulfill a user query or task. For example, the continuous API training service may feed example response data retrieved from the API to an LLM, which may generate summary information indicating particular types of content the API provides, various ratings of the quality or quantity of the content (e.g., whether the API provides detailed data about a particular topic or not), and/or the like. Additionally or alternatively, the continuous API training service may use an LLM to generate summary data based on analyzing past user conversations that invoke the API to determine whether users generally find the API data to helpful or not, what types of users like a particular API, whether users prefer an API for a particular task/query or not, and/or the like. Additionally or alternatively, the continuous API training service may generate and store summary information indicating API uptime, how frequently errors occur or are detected, how frequently the API has Information about a requested entity, various status codes, and/or the like, which again may be used at runtime to select the best APIs for a given task or request. The continuous API training service may store the various summary data in the API analysis database as contextual information about the API.

In embodiments, the API analysis database 162 may further store other analytics data as contextual information about the API. For example, the application may analyze user interfaces with a particular API, including how often user queries were met with error codes, how often users tried other similar APIs after the particular API, how often users submitted feedback relating to a given API, measures of sentiment analysis for user feedback on the API (which may be generated by the LLM or by some other analysis tool), and/or the like. All of the contextual information may be usable at runtime to select the best API to satisfy a particular query.

The continuous API training service may leverage an API routes framework (e.g., the node.js Express framework) to generate API routes for efficient data transfer between frontend and backend modules. The API routes may optimize the performance, scalability, and/or error-handling of the application. The continuous API training service may then store the API routes as endpoint data in API analysis storage.

The continuous API training service may also be configured to generate plain English (or other natural language) commands and other data for storage in recipes and/or schemas for later use. The illustrated function (labeled as “Generate ‘Plain English’ commands) may be configured to translate API data into more user-friendly, plain English commands as well as other formatted data specified by a schema. For example, if an API endpoint includes functionality for sending a message via a chat application, the module may generate a natural language command like “send a message saying “hello team” to the channel #general". In embodiments, the service may use one or more algorithms and/or the LLM to generate the natural language commands based on the scraped/cleaned documentation data and/or other data that is relevant to the API endpoint. For example, the module may prompt the LLM with a query specifying the API endpoint information and asking the LLM to generate one or more natural language commands for invoking the API endpoint. Additionally or alternatively, the LLM may summarize content retrieved from the API endpoint in order to better understand the API. The service may then store the generated natural language commands and/or data summaries in the API analysis database. In embodiments, the continuous API training service may also evaluate key-value pairs in API endpoint data recursively, thereby finding critical elements and/or attributes, which may be stored as endpoint context. As shown in the diagram, the stored endpoint data may include mappings between API endpoints and their corresponding natural language commands, summaries, data types, data structures, and/or the like.

In embodiments, a business logic function (e.g., API to Speech Mappings) may be performed by the logic module 130 and/or the LLM, which may map the API endpoint data (e.g., documentation, other contextual information, etc.) to a schema specifying a natural language command, one or more intents (e.g., a “send” intent for an API endpoint used to send messages), one or more resources, one or more parameters, one or more modifiers, and/or other data specified via a schema. For example, the logic module 130 may parse a document object model (DOM) corresponding to HTML API documentation to retrieve various data values, and leverage an LLM and/or an algorithm to map the various data values to the schema and store the data values as contextual data and/or generate new data values to be stored as contextual data in the API analysis database 162. In some embodiments, the LLM and/or the logic module 130 may adapt a standardized schema to account for API-specific behavior, for example to account for a required number and/or type of parameters that may be submitted via an API. Accordingly, the standardized schema may be flexibly adapted to the needs of individual APIs.

In embodiments, the logic module 130 and/or the LLM may generate natural language commands for recipes that correspond to multiple APIs. For example, the logic module 130 may generate a natural language command for a recipe for sending a chat message, where the recipe may be mapped at runtime to the user’s favorite messaging application and/or the most appropriate messaging application based on a current user context (e.g., device, installed applications, previous interactions, conversation context, etc.) and/or direct user input selecting a particular API or application.

In embodiments, the continuous API training service may be configured to continuously monitor API endpoints, for example, by sending regular test queries to ensure that the API has not changed in function or structure. In the event that the service detects a change, it may cause the platform 100 to re-scrape and browse the updated API, generate new natural language commands, and/or otherwise perform the above operations to update the API in the application.

In embodiments, the platform 100 initiates an onboarding and guidance phase via an onboarding user interface 114 that begins when a user accesses the application and requests to create an account. The user account creation action triggers an initial account setup via the onboarding user interface of the application. This setup process includes the creation of a login, a profile, an email confirmation, and other related procedures necessary for establishing a user account.

Following the setup process, the user account may be classified according to various criteria via the onboarding user interface 114. For example, the onboarding user interface may request and receive information that is pertinent to the account such as industries associated with the account, use cases relevant to the account, interests of the account user, and/or the like. In embodiments, the user account classifications may be provided to a profile generation service 138 that is configured to generate a set of personalized capabilities and preferences and/or to keep set of personalized capabilities and preferences updated (e.g., the personalized capabilities and preferences may be continuously refined as a user interacts with the system, enables and disables capabilities, indicates (e.g., explicitly or implicitly) various preferences, and/or otherwise provides more information about the user). This service may store the personalized capabilities and preferences in a user database 170. In embodiments, the personalized capabilities and preferences can include parameters like enabled capabilities of the platform (as described in more detail below), preferred API providers, API provider(s) that the user subscribes to, synergies between preferred API providers and other API providers (e.g., if a user subscribes to and/or otherwise prefers a first API provider, the preferred API provider may be compatible with some API providers but not others) the user’s preferred communication mode (e.g., text vs. speech), other user preferences (e.g., types of content the user prefers, a level of detail the user prefers, etc.), any usability information (e.g., whether a user is hard of hearing, etc.), language proficiencies, and/or the like. In embodiments, the personalized capabilities and preferences may be used at runtime to select modes of communication, tailor information to user preferences or needs, and/or the like.

As used herein, the term “capabilities” may refer to set of functionalities that may be provided by or otherwise correspond to one or more API providers. For example, an “ecommerce” capability may be associated with various API providers such as SHOPIFY, WOO COMMERCE, and/or other such ecommerce platforms that provide APIs. Similarly, an “analytics” capability may be associated with GOOGLE ANALYTICS, ADOBE ANALYTICS, etc. However, it should be understood that these example capabilities are merely illustrative, and any API provider may be matched to one or more particular capabilities. In embodiments, capabilities may be enabled or disabled for individual users based on user queries or other user data (e.g., user preference data). Thus, for example, if a user has never requested a capability, that capability may be disabled (e.g., if a user has never indicated any desire to use ecommerce APIs, then ecommerce APIs may be disabled until the platform determines that a user is clearly requesting an ecommerce function). The enabling and disabling of capabilities may, in some embodiments, allow for better API matching (e.g., thereby reducing false positives by not searching API providers that correspond to disabled capabilities). In embodiments, various capabilities may be enabled at runtime (e.g., in response to a user query) as described in more detail below.

In embodiments, the platform 100 may receive user requests and provide responses during an interaction phase. The interaction phase may begin when a user submits a task request as shown via a chat user interface 116. The platform 100 receives the user’s task request (e.g., at the user interface (UI) sub-layer) via a chat user interface 116 which is configured to provide a user interface for receiving various requests from the user and providing various responses. In some embodiments, the user interface 116 may comprise a textual and/or visual chat history (e.g., including text, images, audio, and/or the like). Additionally or alternatively, the user interface may allow for voice input (e.g., using speech to text and/or automatic speech recognition to convert voice input into text). In some embodiments, the user interface may not have any visual component (e.g., such that the user may simply talk to the application). In any case, the conversation may involve one or more user requests, which may be initial requests, follow-ups, requests for clarification, and/or other requests, and one or more application responses, thus providing an ongoing conversation between the user and the application.

In embodiments, the chat UI may transmit received requests to a stream chat service 140 that implements capability awareness in the business logic sub-layer (also referred to herein as a “capability awareness service”). In embodiments, the capability awareness service may reference the user’s personalized capabilities and preferences and/or the API contextual information to determine an optimal or otherwise preferred API for satisfying the user query and/or to tailor the user interface, requests, and/or responses accordingly.

In embodiments, the capability awareness service (or another service implemented by the logic module) may be configured to process and analyze the contextual data (e.g., including the API to speech mappings, any summary information, analytics, etc.) stored in the API analysis database in order to determine whether and how a user's request corresponds to a specific API or APIs. In these embodiments, a vector search service 144 may analyze the similarity of the user’s request to the stored speech mappings and other contextual information to determine one or more appropriate APIs (e.g., using vector similarity if the contextual data is stored as vector embeddings, as described in more detail below). For example, if a user asks the voice assistant to "provide me with a one-week vacation opportunity sometime in November, in a location that has an average November mean temperature above 60 degrees Fahrenheit, staying in a hotel that is pet friendly within a walkable distance to an art museum, for a cost under US $X…" the platform, aided by the mappings in the API analysis database and/or recipes database, may identify one or more corresponding APIs that provide location-based services. Additionally or alternatively, the platform may select one or more of multiple APIs that provide relevant services (e.g., location-based services) based on contextual data stored in the API analysis database, such as user feedback, summaries generated by LLMs, etc. In some cases, the stream chat service (or another service of the logic module) may be configured to detect URLs in user task requests and access information available at the URL, which may be provided as context to an LLM or otherwise used in a similar way as API response data.

In certain real-world scenarios, the platform may find a large number of relevant APIs by comparing a user query to API context data using a similarity search (e.g., because there may be dozens or hundreds of location-based services APIs). Accordingly, the platform may further leverage an LLM to process the contextual information about each API as well as personalized capabilities and preferences for a user to detect one or more best matches. Thus, the platform may be configured to leverage the LLM chat API to assist in making decisions about whether a user's request should be used to invoke a particular API or APIs. For instance, the platform analyze the user’s request and, based on the mappings and/or other data in the API analysis database and/or recipes database 180, provide a list of several potential APIs to the LLM chat API along with contextual data about each API and/or the personalized capabilities and preferences. The runtime LLM 214 (or a third party LLM) may then receive the list of potentially-relevant APIs, contextual data for each API, and/or personalized capabilities and preferences, and generate a response that indicates which one (or multiple, if multiple APIs can or should be used) of the listed APIs is a best match for fulfilling the user's request.

In some cases, the LLM’s response may indicate a single best API, which the application may proceed to query (e.g., using an API recipe) automatically. Additionally or alternatively, the LLM’s response may indicate multiple “best” APIs, and the application may present an option for the user to select one of the APIs as desired.

In embodiments, the LLM may select one or more “best” APIs based on various user preferences and/or enabled capabilities, such as a user’s preferred APIs or data sources, familiarity with certain data sources and/or technical concepts, preferred amount of detail when discussing sources and/or concepts, etc., which it may infer from previous interactions stored in the user database. Based on this information, the platform may add (e.g., to an LLM prompt) one or more instructions that cause the LLM to tailor its API selections and/or responses to the user’s preferences, thereby making the interaction more user-friendly and efficient.

As another example service of the logic module, if the user preferences indicate that a particular user has a hearing impairment, the platform may configure other components of the system, (e.g., the chat user interface) to provide visual responses instead of or in addition to auditory ones. Similarly, if a user has a speech impairment, the platform may configure the chat UI to trigger alternative input methods, such as text input or sign language recognition.

Additionally or alternatively, the platform (e.g., via the training/fine-tuning service 146) may implement iterative learning and adaptation over time. For example, by analyzing a user’s behavior, preferences, and/or feedback from past interactions, the platform may continuously refine the personalized capabilities and preferences, thereby improving the platform’s performance and the overall user experience.

Accordingly, the various components of the platform may be configured to serve as a bridge between the user requests and an LLM and/or APIs by tailoring the user interface and/or pre-processing requests before they are sent to an LLM and/or used to select an API, which may provide better operation based on a user’s capabilities, preferences, and/or needs. Furthermore, the platform may utilize the API analysis database’s contextual information (e.g., natural language commands, API summaries and analytics, etc.), as well as a user’s personalized capabilities and preferences, to provide additional context to the LLM to assist the LLM in selecting one or more best APIs.

In embodiments, when the platform generates an LLM prompt (e.g., based on the user request and/or API and/or user contextual information), the platform may transmit the prompt to a third party LLM (or a locally-hosted LLM). The LLM may receive the user request, process the request, and return a response to the platform. In embodiments, the platform may retrieve information from the user database and/or API recipe database for use in prompting the LLM. For example, the API recipe database may contain templates or API recipes for invoking various APIs, where each recipe may include the contextual information described above, one or more natural language commands, one or more APIs that correspond to the recipe, etc.

In embodiments, the platform may generate API recipes at runtime based on a user query. For example, a user query may request performance of several tasks (and/or may request one or more tasks that require multiple API calls to perform). The platform may process the user query to identify the required tasks, map each task to one or more APIs, and generate a recipe for calling the APIs, gathering any necessary information from the user (e.g., required user inputs), performing any ancillary processing (e.g., interstitial tasks and/or post-execution tasks), arranging the tasks in order of dependencies (e.g., parallel, sequential, using conditional logic, etc.), scheduling the tasks, and/or the like. Methods for generating and executing recipes are described in more detail below.

In embodiments, the platform may maintain conversation histories 174, which may be provided to the LLM in order to maintain context over time. In some of these embodiments, the platform may request the LLM to summarize and/or otherwise shorten previous requests and/or responses in the conversation history so that they may fit into a context window of the LLM chat model.

In embodiments, the platform may be configured to invoke fine-tuning functions of the LLM model, as described in more detail below. The fine-tuning operations may be used to train the model based on past conversation history data, recurring query patterns, and/or other data stored in the user database 170, thereby iteratively improving the model using crowdsourced data.

In embodiments, the platform may also implement an asynchronous multi-step task sequencing function, which may be used to call a selected API endpoint either before or after submitting a prompt to the LLM via the LLM chat API. In these embodiments, the asynchronous multi-step task sequencing function may be responsible for formatting and sending the requests to various API endpoints, and/or receiving responses from the API endpoints. The function may gather any data from the API recipe database, which may be used to format the requests, communicate with the different API endpoints, and/or understand the structure of the responses.

In embodiments, the asynchronous multi-step task sequencing function outputs API responses (which may be formatted by the async multi-step task sequencing module) to the chatbot UI module. The chat UI may then send responses, confirmations, summaries, and/or other communication back to the user in the user layer based on the information received from the LLM and/or the responses received from the API endpoints. In embodiments, one or more of the logic module services may handle the combination and formatting of data from the LLM and/or the API endpoints into a single response for the user and/or a series of responses for the user.

In some cases, a response provided back to the user may be a confirmation of completion of a task provided to an API endpoint. For example, an API request may instruct a third-party API provider 230 to perform some action, such as ordering food for a user, adding an event to a user’s calendar, calling a car for a user, etc. In these cases, the API response may indicate that the action was performed and/or status information associated with the action (e.g., an estimated time of delivery or arrival, etc.). In some cases, a summary of the response and status information may be generated by the LLM based on a prompt submitted to the LLM that includes the API endpoint responses and/or status information. The chat UI may therefore provide the confirmation and/or status information (from the LLM and/or API endpoints) to the user.

Additionally or alternatively, a response provided to the user via the chat UI may include information which may assist the user in generating additional task requests and/or refining existing task requests. In these embodiments, the API endpoints may include external search services, which may be used to gather relevant data that may be provided to users as part of a conversation and/or to assist in making further request. For example, the response may include a list of businesses or other information that the user is searching for, which may allow the user to perform follow-up requests based on the information. In embodiments, the follow-up or refinement requests may cause the application to call one or more different API endpoints in succession to complete a complex task. In this way, the application provides a framework that allows a user to carry out complex tasks involving one or more APIs, and may use LLMs to further process the information that is sent to and/or received from the APIs.

The application further implements a post-interaction phase that includes training and fine-tuning of LLM models based on conversation histories, results of API requests, and/or other interactions. In embodiments, a training / fine-tuning service 146 may implement a continuous process that is configured to improve the understanding and/or precision of AI models in handling user requests. This training process may include continually refining AI models (e.g., LLMs) based on evolving user requirements and linguistic nuances. As an example, upon the release of a new feature within the system, the training service may feed sample user interactions into the AI model. The training data may fine-tune the AI model so that it may understand how to handle queries related to the new feature.

In embodiments, the training / fine-tuning service may identify a pattern of misunderstood user commands and provide a set of data configured to improve the interaction of the model with user commands that fit the pattern. In some cases, the training / fine-tuning service may use the LLM to generate synthetic data that may be used for fine-tuning.

In embodiments, the training / fine-tuning service may incorporate a feedback collection mechanism. For example, reporting requests may be received from users, as shown in FIG. 2. The feedback collection mechanism may use surveys, feedback prompts, user interviews, user reports, and/or the like. Via the feedback collection mechanism, the training / fine-tuning service may gather data on system performance and user satisfaction, which may be used to develop and/or generate training or fine-tuning data. For example, if a user provides feedback that a particular term or phrasing was not adequately understood, the training / fine-tuning service may record feedback and provide it to system maintainers (e.g., who may use it to generate additional training data) and/or use the feedback to generate synthetic training data. The training / fine-tuning service may then train / fine-tune the model so that it may recognize and appropriately respond to the designated phrasing in future interactions.

Additionally or alternatively, the platform may detect feedback implicitly from user conversations. For example, the platform may feed a user conversation to an LLM and request the LLM to generate feedback information indicating whether the user was satisfied with a particular API response or not. This information may be compiled into both qualitative feedback (e.g., a textual commentary on whether an API was helpful for a particular use case or not) and/or quantitative feedback (e.g., a percent of users that found the API helpful and/or other such analytic data). In embodiments, the feedback data may be stored in the API analysis database and used for future API selections.

In embodiments, the platform may provide various feedback data to users using a reporting function and/or data visualization function, which may generate images (or other multimedia files or data files) and/or user interfaces that include the feedback, summaries of the feedback, actions taken based on the feedback, and/or the like. In embodiments, the reports may be provided in real-time, at periodic intervals, etc., and may be provided to a single designated user, multiple users, and/or the like. Additionally or alternatively, the platform may store the feedback, training data based on the feedback, various analytics of model performance, etc., in an analytics/behavior database 190.

The training / fine-tuning service may use various technologies for training and/or fine-tuning models, such TensorFlow or PyTorch, BERT (Bidirectional Encoder Representations from Transformers), and/or the like.

In embodiments, the platform may continuously monitor user interactions, continuously update APIs as necessary (e.g., to add new APIs and/or fix broken APIs), and otherwise implement continuous and/or iterative improvement processes. In embodiments, the platform may continuously monitor and detect anomalies, monitor the overall health of the system (e.g., via performance metrics for various modules, AI models, etc.), and/or the like. In embodiments, the platform may leverage existing monitoring toolkits (e.g., PROMETHEUS) to continuously monitor the system for anomalies or potential issues and to send alerts to a system administrator for review. Additionally or alternatively, the platform may implement continuous updates to handle changes in external APIs, evolving user behaviors, and other changes.

In embodiments, the platform may store user chat histories and user profiles for the purpose of providing a personalized user experience, predicting user needs, etc. For example, a user may provide feedback on a recent conversation or interaction, which the application may store and later use for fine-tuning. In embodiments, user data may be stored in a document-based distributed database (e.g., MongoDB). The platform may leverage the user data to enhance user experience by personalizing responses and predicting user needs. In embodiments, the data storage may adhere to various data protection standards, may implement various authentication, encryption, and security protocols, and otherwise ensure privacy and security. Furthermore, the platform may allow users to opt-out of data collection or request data deletion. For example, during the sign-up process, users may be provided with an option to opt-out of some or all types of data collection. Additionally or alternatively, the platform may include user settings that allows users to request the deletion of their personal data at any time.

In embodiments, the platform may store any of the data described herein as embeddings data (e.g., in a vector database or otherwise). Embeddings data may include data indicating the semantic relationships between various words and phrases. The embeddings data represent words and phrases in a multi-dimensional vector space that can capture the interconnections between similar linguistic elements. In embodiments, the application may use an embeddings model or framework (e.g., TensorFlow) to create the embeddings.

In embodiments, the embeddings may be stored in vector databases, which facilitate rapid retrieval and analysis of vectorized data based on contextual similarity. In embodiments, the platform may use any vector database or library (e.g., FAISS) to efficiently perform similarity search and/or clustering of dense vectors. The platform may index and store various content in vector databases such that it is retrievable without conflicts.

In embodiments, the platform may identify a need for more nuanced embeddings for particular use cases. In these cases, the platform may expand a database to include new embeddings and ensure that the new embeddings coexist with existing embeddings without redundancy. Additionally or alternatively, the platform may assist developers or other users in understanding the efficiency of current embeddings. For example, the platform may query the vector database to retrieve specific embeddings and the platform may analyze the effectiveness of the embeddings for real-world queries. The platform may further detect feedback (e.g., via user feedback and/or automated monitoring) indicating that certain terms or phrases are not understood correctly. In response, the platform may update or expand the embeddings in the vector database to improve understanding and accuracy.

In embodiments, data stored by the platform (whether vectorized or not) may be stored using a database schema that ensures the integrity of the data, efficient storage, and rapid retrieval. In some embodiments, when a newly-added feature requires the storage of additional data types, the platform may modify the schema and/or generate a new schema to accommodate new data types. The platform may be configured to populate the databases with relevant, accurate, and validated data. For example, during integration of a new API, the platform may validate the data provided by the API before populating a database to ensures the integrity and relevance of the data. The databases may include SQL and/or NoSQL databases for structured and/or unstructured data storage and retrieval.

In embodiments, the Large Language Models (LLMs) described herein may include state-of-the-art LLMs like GPT (Generative Pre-trained Transformer) and/or various open-source LLMs, which may be provided by third parties and/or hosted locally.

In embodiments, the platform allows for data collection on human queries and API-level interactions. This may provide for large training datasets that can be used to train and build LLMs proficient in predicting API-level actions across vast numbers of APIs based on human language.

In embodiments, the platform leverages advanced predictive analysis techniques to anticipate user needs and provide proactive assistance. For example, the platform may implement predictive analysis algorithms that take into account historical data and/or current interactions, thus allowing the system to deliver proactive and tailored assistance. As one example, the platform may leverage such algorithms to predict a user’s need for information on a specific topic based on their previous queries and provide relevant information proactively. In some embodiments, the platform may connect to data sources that may provide situational user data, such as calendaring applications that may provide time-based events and/or tasks, task management applications that may provide due dates and/or recurring tasks, and the like. In these embodiments, the platform may feed the situational user data to the LLMs and/or process that data using various business logic modules to provide appropriate assistance based on the context (e.g., reminders for events, assistance in completing tasks and/or preparing for meetings, and/or the like).

The platform may be tailored to specific use cases using various techniques. For example, developers may integrate a new vector database to improve an AI model’s understanding of a specific industry. Additionally or alternatively, if the platform receives a request containing an unfamiliar industry-specific terminology, it may leverage LLM integrations to enhance its comprehension and response accuracy.

In embodiments, the platform may facilitate user collaboration, such as by allowing multiple users to engage with the platform simultaneously and/or integrate with external systems to facilitate the sharing of data/insights, to leverage collective intelligence among users, and/or the like. Accordingly, the platform provides for multi-user collaboration by allowing multiple users to join a session, share data, and collaborate in real-time. For example, a team working on a project may collectively contribute to a conversation session with the chat application, such that each team member may see the other team member’s requests and responses to the requests. In these embodiments, the platform seamlessly syncs data and interactions among team members.

The platform further integrates with external systems via APIs (Application Programming Interfaces) and connectors, which allow the platform to fetch and push data as required to enable integrations. API connectors may include tools and libraries that facilitate the integration of the application with external systems. Moreover, if a request is made for integration with a third-party tool, the platform’s integration features enable smooth data exchange and real-time updates. The platform may also implement data syncing agents that are configured to ensure that all data is updated in real-time (e.g., via WebSockets).

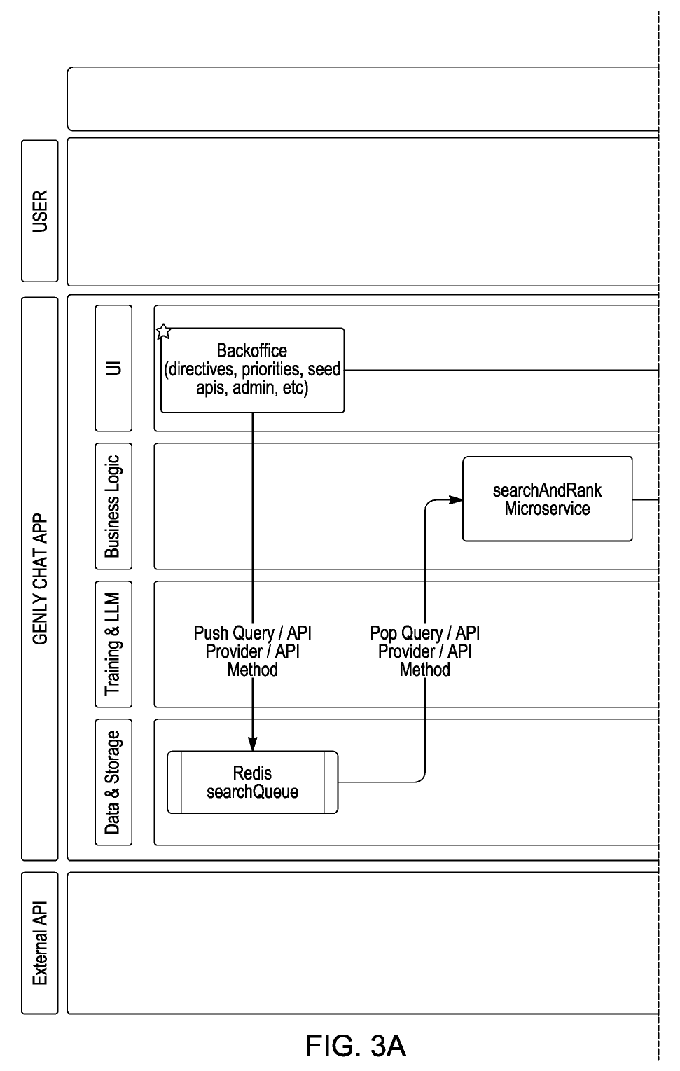

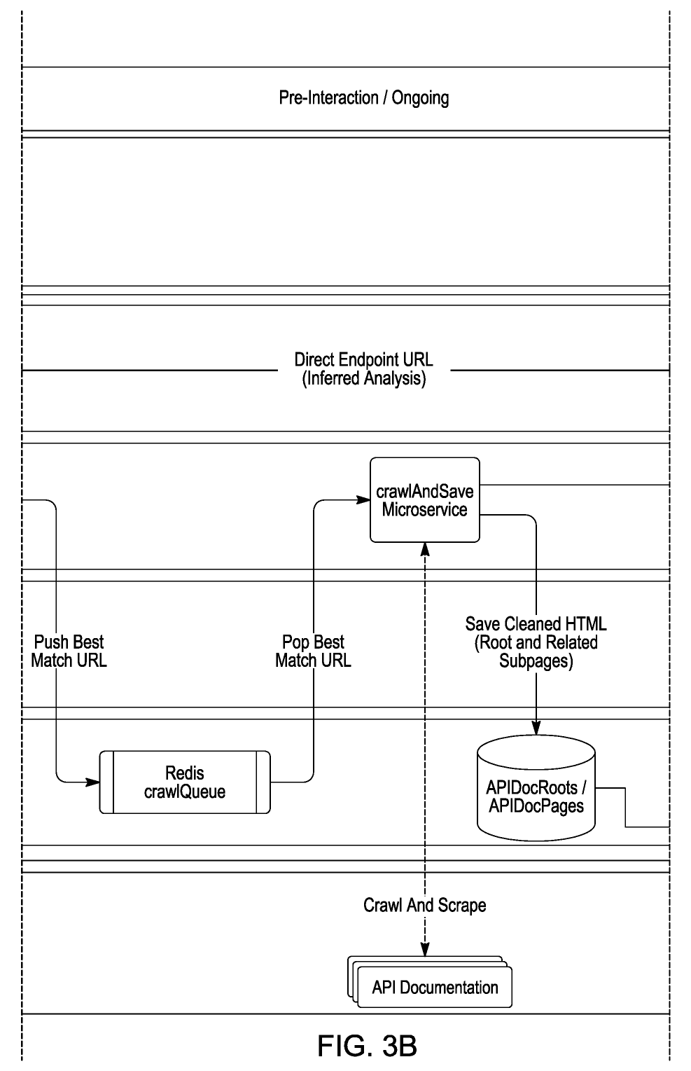

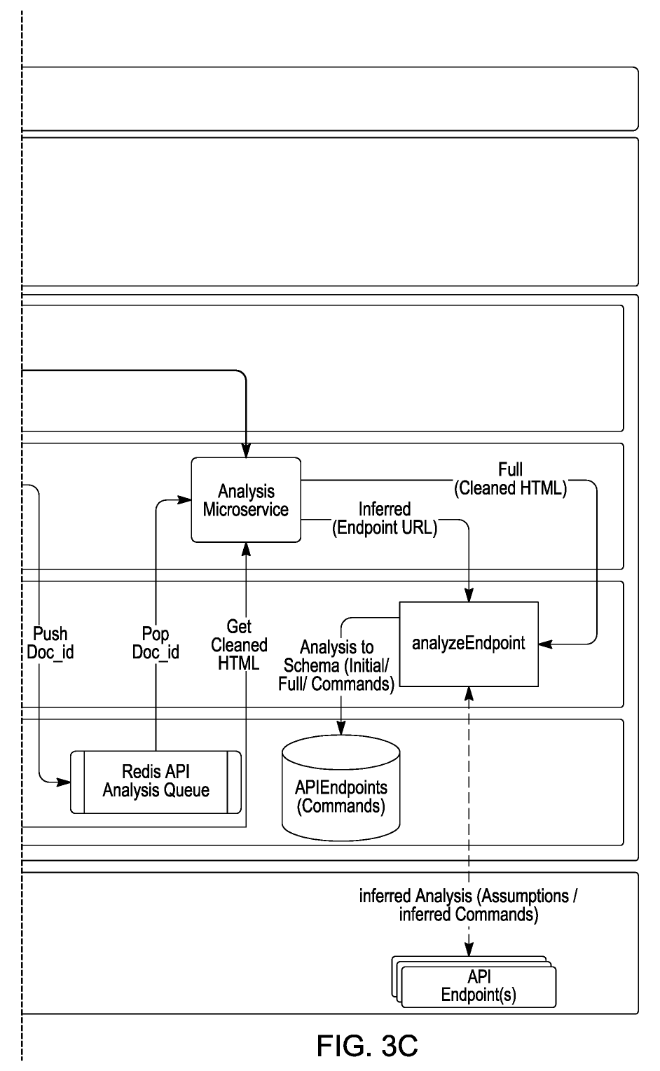

FIG. 3 (i.e., FIGS. 3A-3C combined) illustrates a detailed flow diagram showing an implementation that includes several services configured to perform the pre-interaction/ongoing phase. As shown in the diagram, the services may include a search and rank microservice 132, a crawl and save service 134, and an analysis service 136. Although the various components are shown in the figure as microservices, in embodiments the functions ascribed to these and/or other modules/components may be performed by a single module and/or by various components that follow various architectures. In other words, a microservice architecture is merely exemplary.

The flow diagram shows two distinct pathways for performing 1) a full documentation analysis (e.g., for an API with documentation available) and 2) an inferred analysis (e.g., for a private API or an API that is otherwise lacking available documentation). However, it should be understood that both a full documentation analysis and an inferred analysis may be performed either serially or in parallel. Therefore, although two analysis pathways are illustrated, the various steps may be performed as a single analysis and/or in various sequential orders.

In embodiments, the platform 100 may initially receive a query or another indicator of an API provider or API method from a back-office user interface, as described above. For example, if an administrator wishes to configure a new API or type of API for use by the platform, the administrator may provide one or more keywords that describe the API (or a function of the API), the domain, or a specific method of the API. The back-office user interface may then transmit the query or other indicator to a queue. In turn, the query may be popped from the queue by a search and rank microservice. The search and rank microservice may then generate and execute a search strategy aimed at locating URLs of documentation pages that match the query/indicator.

For example, the admin user may wish to ingest the entire API for a specific web service (e.g., a travel site with an API for booking flights, hotels, etc.). In this case, the user may provide a query indicating the name of the service, the name of the website (if different), and/or a description of the travel site (e.g., “travel site with API for booking flights and hotels”). The search and rank microservice may then locate one or more documentation pages for APIs that match the query. This process involves searching for one or more URLs of pages, subpages, and/or any other resources where the documentation may be found. The documentation may reside at the API provider’s domain or another site.

In embodiments, the search and rank microservice may use keyword searching techniques to find the documentation pages. For example, the search and rank microservice may extract one or more search terms from the query/indicator provided by the back-office user interface (which may include keyword(s), domain name(s), function(s), API-specific method(s), etc.) and may optionally add additional keywords (e.g., “documentation”). The search and rank microservice may then search various databases and/or online resources (e.g., search engines, API directories, developer forums, technical blogs, etc.). Using the keywords, the search and rank microservice may execute a keyword search that identifies and ranks a list of potential documentation pages.

Additionally or alternatively, the search and rank microservice may use advanced search algorithms such as machine learning and/or natural language processing algorithms (or other AI methods). In some cases, these techniques may be more performant at understanding a context of a search, interpreting the semantics of a query, and/or providing more accurate results.

Similarly, if the designation pertains to a specific API provider, the search and rank microservice may locate the documentation for that API provider. If the designation pertains to an API method, the search may be more specific, targeting documentation for a specific method instead of every endpoint of the API.

For each search, the search and rank microservice may generate one or more potential matches (e.g., URLs). If a match ranks highly enough (e.g., above a relevance threshold) and/or otherwise qualifies as a good match (e.g., an LLM may be used to assess the match quality), the search and rank microservice may add the URL to a crawl queue. In the illustrated embodiment, the crawl queue is a REDIS queue stored within the platform’s local memory. In some embodiments, a single “best match” may be added to the crawl queue for each search. Additionally or alternatively, a search may yield multiple matches that may be added to the crawl queue. In some cases, the search and rank microservice may be unable to locate any relevant documentation. In these cases, the system may switch to an “inferred analysis” procedure described in more detail below.

Assuming at least one relevant documentation page is found, the crawl and save microservice may then generate and store a “docroot” data structure for each URL added to the crawl queue. The docroot data structure may include the URL, the HTML that is accessible at the URL, an HTTP eTag (which may be taken from an HTTP response header) or other metadata that uniquely identifies the content of the URL, and/or other data fields. The docroots provide a long-term record of the URL and its associated eTag. This record indicates that the content at the URL was previously found and ingested. Thus, if the search and rank microservice later finds the same URL and eTag for a different search, it can avoid adding the URL to a crawl queue in order to avoid re-generation of the same docroot twice. However, if the documentation is later updated, the web server automatically updates the HTTP eTag, which causes the platform to add the URL to the crawl queue for re-scraping of the updated content, generate a new docroot for the updated content, etc. Accordingly, the eTag (or some other equivalent data structure, such as a hash of the HTTP data that may be generated by the platform) enables the platform to avoid redundant data ingestion.

Although the searches as described above may originate from inputs provided by an admin user, in other cases the searches may originate from user requests provided at runtime. For example, if a user request for information from an API (whether named or not) does not yield a good match at runtime, the platform may attempt to ingest additional APIs that will be able to better satisfy the user request either at runtime and/or for future similar requests. In these cases, a detected user intent (described elsewhere herein) or full user query may be provided to the search and rank service, which may find new or updated APIs that may better handle the user query. Additionally or alternatively, the platform may regularly initiate updated searches and/or scrapes in order to receive the latest documentation on each of the APIs used by the platform.

When the crawl queue includes one or more URLs of relevant API documentation pages, the crawl and save service may pop items off the scrape queue for processing (e.g., as platform processing bandwidth or capability allows).

In embodiments, the crawl and save microservice scrapes and scrawls each URL popped from the queue. For example, the crawl and save service may access the URL in the docroot (and/or simply access the saved HTML from the docroot) and crawl through all the links, sublinks, and/or subpages within the HTML page (e.g., up to a certain number of levels deep) to find related documentation sub-pages. In embodiment, for each URL that is accessed by the crawl and save microservice (e.g., including the root URL and all subpage URLs), the crawl and save microservice generates a “docpage” data structure including several fields and values. The docpage data structure may include the URL and cleaned HTML. The crawl and save microservice may access the URL and clean the HTML prior to storage. The cleaning process may involve removing unnecessary metadata, scripts, styles, and/or other non-essential elements. In addition to the URL and cleaned HTML, each docpage data structure may also include timestamps indicating when the docpage was generated and/or when the page was scraped and/or other optional metadata.

In embodiments, the docpage data storage stores a plurality of docpages, where each docpage is specific to a URL. Depending on how the documentation is set up, there may be documentation for multiple API commands within the HTML for each docpage. Accordingly, as described above, the crawl and save microservice may transform each docroot into one or more docpages. Generally, the number of docpages may be greater than the number of docroots due to the scraping process that follows links and explores subpages from each root URL to scrape the entire API documentation.

In embodiments, after the crawl and save microservice generates the docpages, it may provide the doc ID for each docpage to an analysis queue. An analysis service may then pop the data from the analysis queue (e.g., a REDIS queue) as processing capability allows. Once popped from the queue, the service may analyze the data, which may include sending the items to an LLM to analyze endpoint data.

The analysis service may generate an “endpoint analysis” data structure based on the cleaned HTML for an endpoint. The analysis service may leverage an LLM to generate data values for the endpoint analysis data structure. For example, the analysis service may provide a custom prompt indicating the analysis that should be performed by the LLM (e.g., including data fields for the endpoint analysis data structure that the LLM should generate values for). Furthermore, the custom prompt may the cleaned HTML and/or any other documentation information for analysis by the LLM.

In embodiments, the LLM prompt may instruct the LLM to generate an API call example (e.g., an example URL that calls the endpoint using example parameters or other arguments). In embodiments, the example URL may include text fields that may be filled using entity names or identifiers, queries, and/or other text data. The prompt may instruct the LLM to generate the API call example based on the documentation.

In embodiments, the LLM prompt may instruct the LLM to generate one or more keywords describing the endpoint. The prompt may indicate that the keywords can include keywords indicating, for example, the name of the API service, the function of the endpoint, types of data that can be provided to the endpoint, and/or the like. The prompt may further indicate that the keywords are intended for later use by the system in order to find the endpoint when matching the endpoint to user requests.

In embodiments, the LLM prompt may instruct the LLM to generate a plain language summary of the endpoint. Additionally or alternatively, the LLM prompt may instruct the LLM to generate various key-value pairs for various parameters or other fields that may be provided to the endpoint as part of the API, data types for the key-value pairs, the function(s) of the various data fields, and/or the like. Accordingly, the endpoint analysis data structure may include as much contextual information as possible for helping to select an API as the correct API to satisfy a user request and to generate a correct and effective API call for the API endpoint.

In embodiments, the LLM prompt may instruct the LLM to generate a confidence score measuring the LLM’s confidence in the correctness of the other data values based on the documentation. For example, the prompt may instruct the LLM to assess the documentation (in terms of quality and/or completeness), determine if it is well-structured and consistent, and generate a confidence that the generated data values align with the documentation and appear to be accurate. In this regard, the confidence score may be used for quality control (e.g., admin users may manually check analyses with low confidence scores) and/or to prompt searches for additional documentation by the platform. Additionally or alternatively, the confidence scores may be updated later based on successes or failures of later attempts to call the API using the endpoint analysis.

The endpoint analysis data structure may correspond to multiple commands because there may be multiple ways of calling a specific endpoint, multiple functions available via an endpoint, etc. Accordingly, the analysis service may further generate an individual command data structure for each command, where each endpoint analysis data structure may map to multiple command data structures. Again, the LLM may assist in identifying commands and generating the command data structure.

In embodiments, the analysis service may generate a custom LLM prompt for each command and provide the custom LLM prompt to the LLM for generating of the command data structure. Ine embodiments, the prompt may include a schema that describes a set of data fields for the command data structure and explanations of the content that should be stored in each data field. The prompt may further request the LLM to generate the values for the data fields based on the instructions, schema, and cleaned HTML for the endpoint.

In embodiments, the LLM prompt may instruct the LLM to generate a field indicating a full description of the function of the command. As an example, the full description may indicate “search for hotels available between 1/1/23 and 1/7/23.” The LLM may generate the full description based on the API documentation, examples provided therein, etc.

In embodiments, the LLM prompt may instruct the LLM to generate several additional fields for each command. These fields may include an “intent” field indicating an intent (e.g., an action) provided by the command. For example, the intent for the above example may be “search.” The fields may further indicate one or more parameters (e.g., example dates in the above example), a resource (e.g., hotels in the above example), other data, modifiers, etc.

In embodiments, the analysis service may store the various values generated by the LLM in an endpoint analysis data structure and/or one or more command data structures. In embodiments, each command data structure may include an identifier for a corresponding endpoint analysis data structure (e.g., such that each command is linked to the various keywords, API call examples, etc. of the endpoint analysis as discussed above).

In embodiments, the analysis service may perform the schema-based analysis described in three steps: 1) an initial endpoint analysis based on the documentation, 2) a full endpoint analysis that takes into account one or more responses to actual API calls, and 3) a command analysis that generates a command data structure using the command schema. In particular, the first and second endpoint analysis may differ because the analysis service may have additional information available after one or more API responses have been received. Using the API response data, the LLM may generate a better API summary, a better set of keywords, more and/or better key/value information, and/or other such information for the endpoint analysis data structure.

In embodiments, the analysis service (or another service) may further pre-generate embeddings for one or more of the above command fields. The embeddings may be used at runtime to match the user query to a command using a vector search (described elsewhere herein). For example, the platform may generate and store embeddings for the full description field, the intent field, the parameters field, the resource field, the data field, the modifiers field, etc. As described elsewhere herein, the platform may generate the embeddings by tokenizing the data values (e.g., the phrase “search for hotels available between 1/1/23 and 1/7/23”) and providing the token values as inputs to an embeddings model. Then, if a user later submits a similar request such as “find me a hotel for tonight,” the embeddings generated for the user request may be similar to the pre-generated embeddings, such that the command will be findable using a vector similarity search.

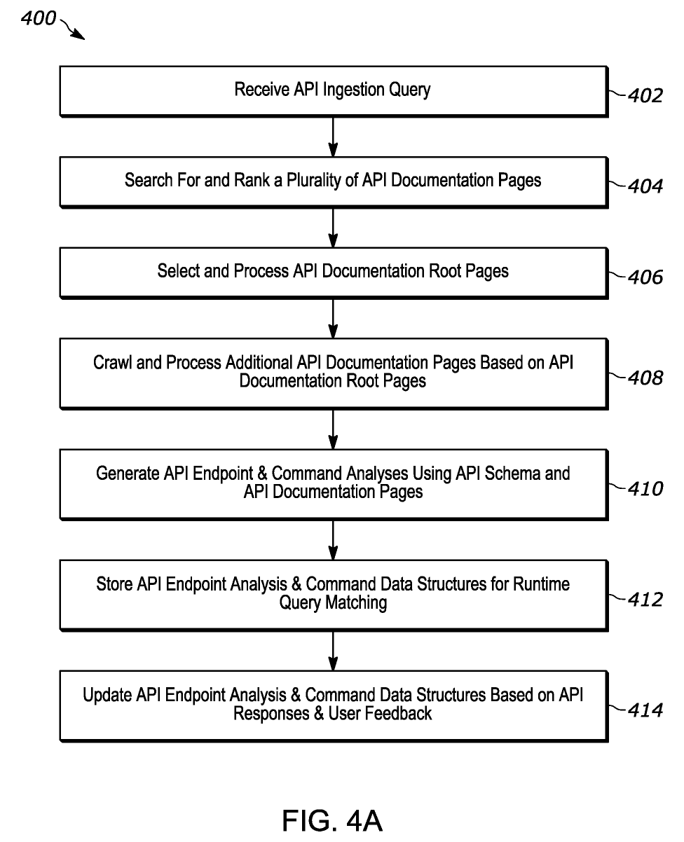

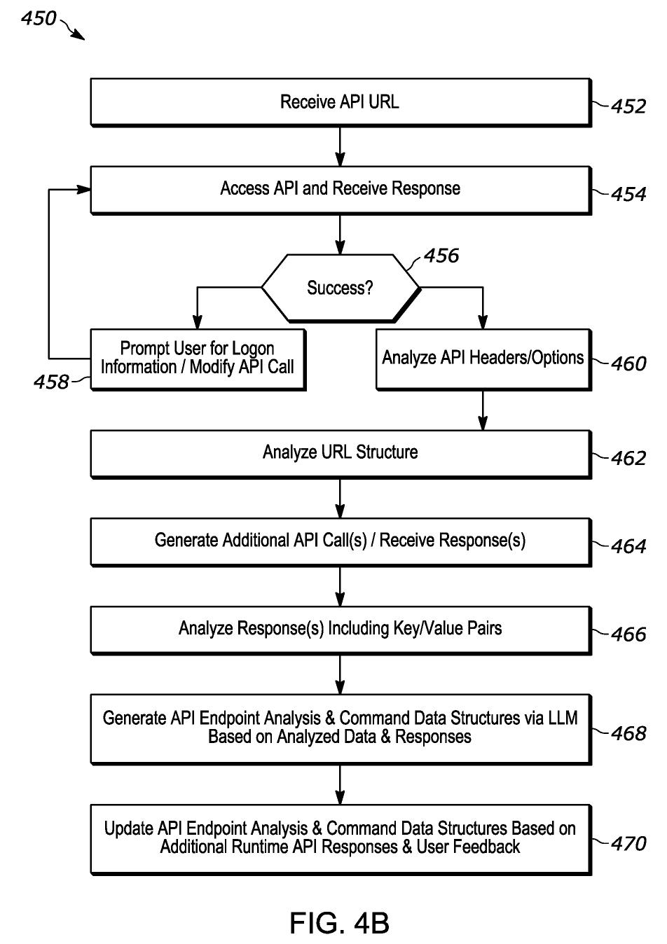

FIG. 3 (i.e., FIGS. 3A-3C combined) also illustrates a second flow for performing an “inferred analysis” when no (or insufficient) documentation is available. The inferred analysis may begin either after a user inputs a direct endpoint URL into a manual queue (e.g., a user may provide the URL for inferred analysis) as shown in the figure and/or after the search and rank microservice fails to find relevant documentation for an API (not shown in the figure). For an inferred analysis, the analysis service may call the direct endpoint URL, receive the response, and generate the endpoint analysis and/or command data structures as described above based on the URL, the response, and/or the like. Additional details of an example inferred endpoint analysis are described in more detail below with respect to FIG. 4B.

FIG. 4A illustrates a method 400 that may be used by a platform as described herein for analyzing API documentation to make APIs available for query matching at runtime (e.g., in response to user requests). FIG. 4B illustrates a method 450 that may be used by the platform for performing an inferred endpoint analysis when API documentation is not available. The methods of FIGS. 4A-B equip the platform 100 with a suite of capabilities that allow it to discover, understand, and index API endpoints provided by different third-party software systems. The platform’s API discovery system is capable of identifying and grouping similar API endpoints based on features such as their respective functions, input parameter types, input types, output types, and/or associated documentation. To enhance its learning, the platform employs an API scraping system to gather data and crawl through API documentation of third-party systems. The platform incorporates an API learning system that utilizes a large language model or other generative AI model to comprehend the capabilities of an API endpoint from the scraped data. Furthermore, the platform can discover and classify API endpoints that cater to specific user requests and/or align with the set of applications used by the user.

At step 402 of method 400, the platform may receive an API ingestion query. The API ingestion query may be received from a back-office user interface and/or may be received based on a context of runtime user conversation. In the latter case, the platform may detect that a user is requesting access to an API that has not yet been ingested and/or that a user is requesting a function with no corresponding API that has been ingested, and leverage the LLM to generate an API ingestion query. The API ingestion query may indicate a particular API provider, API function, or any other relevant keyword or set of keywords.

At step 404, the platform may search for and rank a plurality of API documentation pages. The platform may use various search services or algorithms (e.g., search engine websites, websites that catalog API documentation, etc.) to find API documentation pages based on the API ingestion query. The search services/algorithm and/or the platform may rank the documentation pages based on their content, similarity to the keyword(s), and/or other metrics such as metrics of API quality, popularity, etc.

At step 406, the platform may select and process one or more API documentation root pages from the ranked plurality of API documentation pages. For example, the platform may select the top-ranked documentation pages (e.g., the top-ranked N pages, the pages over a threshold ranking, etc.) based on the ranking and generate a “docroot” data structure as described above for each selected documentation page. In embodiments, the platform may clean and/or otherwise perform processing steps on HTML or other documentation data, which may be stored within the docroot with any associated metadata (e.g., ETags).

At step 408, the platform may crawl and process additional API documentation pages based on the API one or more selected API documentation root pages. For example, the platform may follow links to sub-pages (e.g., up to N levels deep) and store a “docpage” data structure for each documentation page, where the docpage may include cleaned or otherwise processed HTML or other documentation data, timestamps, other metadata, etc.

At step 410, the platform may generate API endpoint and command analyses using an API schema and the API documentation pages. In embodiments, the platform may leverage an LLM (e.g., either locally or remotely hosted) to analyze the API documentation and generate data fields that follow a predefined schema for describing an API command and API endpoint. For example, the platform may generate one or more prompts describing the schema (e.g., including the associated fields and values) and including the API documentation data (e.g., cleaned HTML) and instructing the LLM to generate values for each field. In embodiments, the LLM may generate “command” and “endpoint analysis” data structures with the various data fields as described above. This step may be repeated for each API command available via the API and for one or more API endpoint(s) corresponding to the command(s).

At step 412, the platform may store the API endpoint analysis and command data structures for runtime query matching. The platform may pre-generate embeddings for some or all of the fields for each command, as described above. The pre-generated embeddings may be matched at runtime to embeddings derived from a user query using a vector similarity search to find an API command that is relevant to the user query.

At step 414, the platform may (e.g., at runtime and/or during a post-runtime update phase) continuously update the endpoint analysis and/or command data structures based on API responses received for runtime API calls. For example, new optional parameters, additional knowledge about data fields, and/or the like may be received and verified over time as additional API calls are returned.

Turning to FIG. 4B, at step 452 of method 450, the platform may receive a URL for an API. The API URL may be received via a back-office user interface and/or from other components of the platform. For example, a user may directly input an API URL at runtime and/or a search and rank microservice may find an API URL (e.g., if it cannot find a documentation URL as described above).

At step 454, the platform may access the API URL, thereby calling the API and receiving a response. In embodiments, because the platform does not yet know of any required and/or optional data fields (e.g., POST fields), the platform may simply “test” the API URL to see what happens, what the response indicates, whether security is required, and/or the like.

At step 456, the platform may determine, based on the response to the API call, whether additional information (e.g., logon information, required parameters, etc.) is needed. For example, the API response may include error messages that may specify missing parameters, headers that may indicate required information, and/or the like.

If additional information is needed (e.g., the call was not a success), then at step 458 the platform may prompt the user (e.g., the back-office user / admin user if the API URL was received via the back-office user interface) for logon information, attempt to provide required data fields based on the response, and/or otherwise modify the API call. The process then loops back to step 454.

If the call was a success (e.g., additional information was not needed), then at step 460 the platform may analyze API headers and/or options received from the response. For example, the headers may contain information about the server (e.g., protocols supported), about further access methods, about the client that initiated the request, and/or the like. The platform may analyze these and other data fields of the header to determine information about the API’s functionalities and/or restrictions.

At step 462, the platform may analyze the URL structure to determine any URL query string parameters, including data types, whether the parameters are optional, and/or the like. For example, the platform may parse the URL to identify the base URL, path, and/or one or more query strings. Additionally or alternatively, the platform may analyze the URL to find parameters within the URL that may be variable or optional (e.g., if the parameter is set to an empty value, it may be optional). Additionally or alternatively, the URL may contain specific IDs, names, or other data values of various types that may be replaced with other values (of the same type or possibly a different type) to receive different results.

At step 464, the platform may generate additional API calls based on the information and analyses gathered so far. The platform may accordingly generate one or more additional API calls and received one or more additional responses. For example, based on the analysis of the API headers, options, and/or URL structure, the platform may generate additional API calls that may include different values (of the same data type or possibly of different data types) for any optional or variable parameters in the URL structure, for POST data fields, and/or the like.

At step 466, the platform may analyze the various responses, including the key/value pairs in the response, to determine data fields that may be retrieved, the types of data included in the response(s), and/or the like. For example, the platform may look at the structure and content of the response data to understand the types of data that the API can return, how the types correspond to specific parameters, including optional parameters, and/or the like. In embodiments, the platform may record all of the key-value pairs in the response data as indicators of the structure and contents of the API's response.

At step 468, the platform may generate an endpoint analysis data structure as described above based on the various data analyzed as described above and/or based on the various responses received from the API. The platform may prompt an LLM with this data and with an endpoint analysis schema, thereby causing the LLM to generate the endpoint analysis data structure. For example, after receiving the API headers, options, URL structure, and responses, the LLM may be able to generate an endpoint analysis data structure including an API call example, keywords describing the endpoint, a plain language summary of the endpoint, key-value pairs for various parameters, and/or a confidence score, as described above. Additionally or alternatively, the LLM may generate one or more command data structures based on the same data and using a command data schema (e.g., specifying an intent, resources, parameters, modifiers, etc.) as described above.

Accordingly, although the inferred analysis may require more testing than a full API documentation analysis, it may nevertheless generate a similarly rich set of contextual information about the API endpoint that may be iteratively refined over time. This contextual information (e.g., endpoint analyses and command data structures) may be used for runtime query matching, as described elsewhere herein.

At step 470, the platform may continue to update the API endpoint analysis and/or command data structures based on additional runtime queries and/or user feedback, as described above for step 414.

Via its continuous learning capability (e.g., as described at steps 414/470), the platform thus provides an API discovery system that leverages an LLM for continuous learning and analysis. The platform is capable of handling both documented APIs with API documentation and undocumented APIs without such documentation. In embodiments, the platform may be configured to analyze API endpoints of undocumented APIs by testing varied combinations of inputs and analyzing the corresponding output. In addition, the platform may group similar API endpoints based on one or more features such as user parameters, use-case parameters, etc.

The platform’s continuous learning capability further provides an AI-driven feedback system that improves API contextual data based on data about APIs, user personas, sessions, enterprises, and/or activities and/or based on the requests received by the platform, the responds to API calls, and corresponding user feedback. In embodiments, the platform may analyze group-level API usage and/or individual user interaction with APIs to update API contextual data. The platform thereby is capable of adapting to the preferences of individual users and/or entire enterprises or other groups.

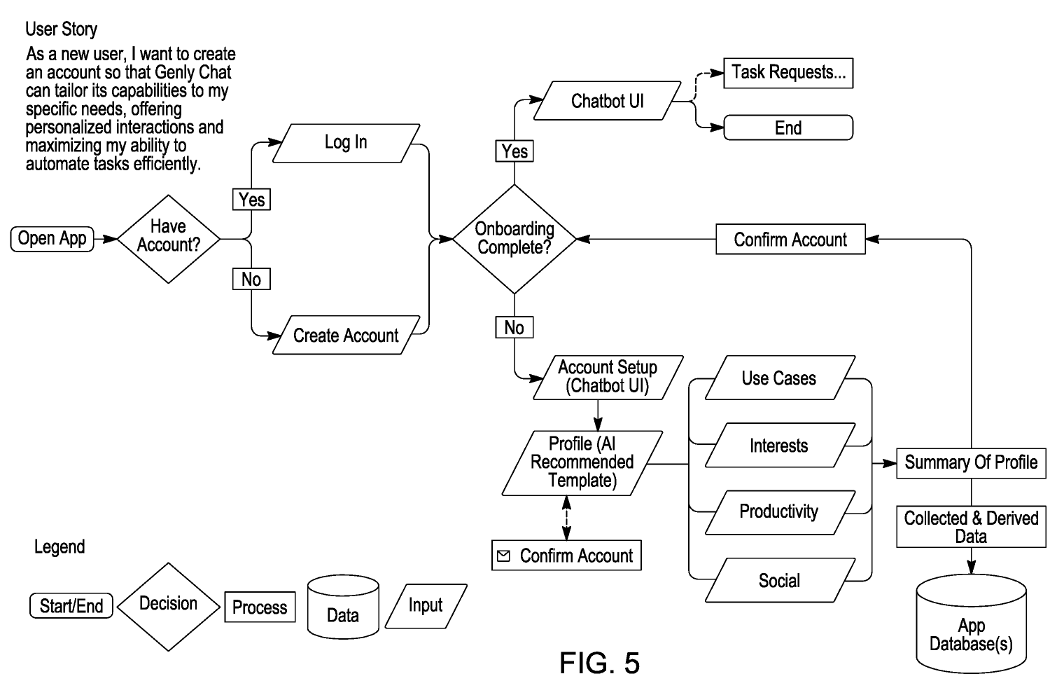

FIG. 5 is a flow diagram illustrating a log-in and onboarding process that may be implemented by the onboarding user interface 114. The diagram is one example implementation of an onboarding and guidance flow. A user may begin the flow by opening the Genly Chat application, which is an example implementation of the API-enabled chat application described herein. Opening the application may include starting up or accessing a mobile application, native application, web application, or any other implementation of the application that may run as a standalone client application, client-server application, web application, distributed/decentralized application, or any other application.

The onboarding capability of the platform is configured to provide a personalization system that uses AI services (e.g., LLMs and/or other AI technologies) to create specific user profiles. These profiles allow the platform to customize the selection and orchestration of API endpoints when servicing client requests. The AI services may include one or more of an LLM or other generative model, a clustering service for user profiles, a behavior tracking and classification service, and/or a use case profiling and clustering service. The platform may create entity profiles not just for individual users, but also for enterprises, workplaces, customers, groups, personas, etc. Multiple of these entity profiles may be used by the platform simultaneously (e.g., an user profile and a group profile for a user who is a member of a group) to further personalize the API orchestration, thereby provide a personalized experience based on users’ specific needs and the feedback they or others provide to the platform.

The flow may proceed by determining whether the user has an account (e.g., by checking stored login credentials, prompting the user to sign in or create an account, etc.). The user be logged in using input or stored credentials if they exist, or may create an account to establish credentials. Then, the flow may proceed by determining whether onboarding is complete. If onboarding is complete, the user may access a chatbot user interface, generate task requests, and/or otherwise engage with the system. If onboarding is not yet complete, the application may guide the user through onboarding using an account setup user interface.

In embodiments, as shown in the figure, the account setup procedure may involve generation of a profile. The profile may be generated based on user inputs and/or automatic inferences made by the application based on data about the user that is available to the application. For example, a user may input preferred use cases, interest, preferred productivity applications or services, preferred social applications or services, and/or the like. As an example, a user may input several services or applications that they have accounts for and/or desire to use in conjunction with the application. As a specific example, if a user wishes to use the application for travel-related functions, a user may provide input indicating their interest in travel, input indicating their preferred airlines (e.g., optionally including whether they have accounts with each airline), input indicating preferred car rental companies, hotel accounts, car rental accounts, travel aggregator accounts (e.g., KAYAK or the like), and/or other such services or more general interests or use cases. In embodiments, the user may provide more fine-grained input if desired, such as rankings of different airlines or hotel chains or other information that may be used by the platform to preferentially select one API over another. As another example, a user may specify the user’s preferred cloud service for storage of files, a user preferred email service, other communication services they use, and/or other such information that may be used to select APIs for different use cases.

In some cases, the platform may automatically determine or infer potential applications that may be preferred by the user. For example, during on boarding, the application may request and obtain access to user information such as a list of the user’s applications installed on the user’s device, a list of web services used by the user, usage data indicating a user’s most frequently used applications or web services, and/or the like. In some cases, the platform may request user confirmation that the user prefers or wishes to use a particular application or service that it has detected. In some cases, such usage data may be used by the platform to generate preferred services, ranked lists of preferred services (e.g., with a more frequently used service ranked higher), and/or the like.

The platform may generate a profile summary and/or capabilities summary based on the user inputs and/or automatically detected or inferred data and/or any data derived therefrom (e.g., rankings of applications or services). The profile summary and/or capabilities summary may include lists of services the user has a logon for , lists of preferred services or applications, and/or platform capabilities that should be enabled for the user (e.g., ecommerce). The platform may store such data in app databases that may be used to automatically tailor the service to a user’s preferred capabilities, applications, and services. When the user completes the onboarding process, the user may be redirected to the chatbot user interface to begin interacting with the application. The profile and/or capabilities data may then be used by the platform to suggest recipes and/or to select APIs to fulfill user task requests, as described elsewhere herein.

In embodiments, the platform may continuously update the user profile based on a user’s usage of an application. For example, if a user provides login credentials for accessing a new API, the new API may be added to the user’s profile as a capability and/or as a preferred application or service. Additionally or alternatively, if a user frequently selects one specific API over another (e.g., the user continuously selects to book travel via KAYAK vs. EXPEDIA or vice versa), the user preference may be recorded in the user profile and used for future task requests.

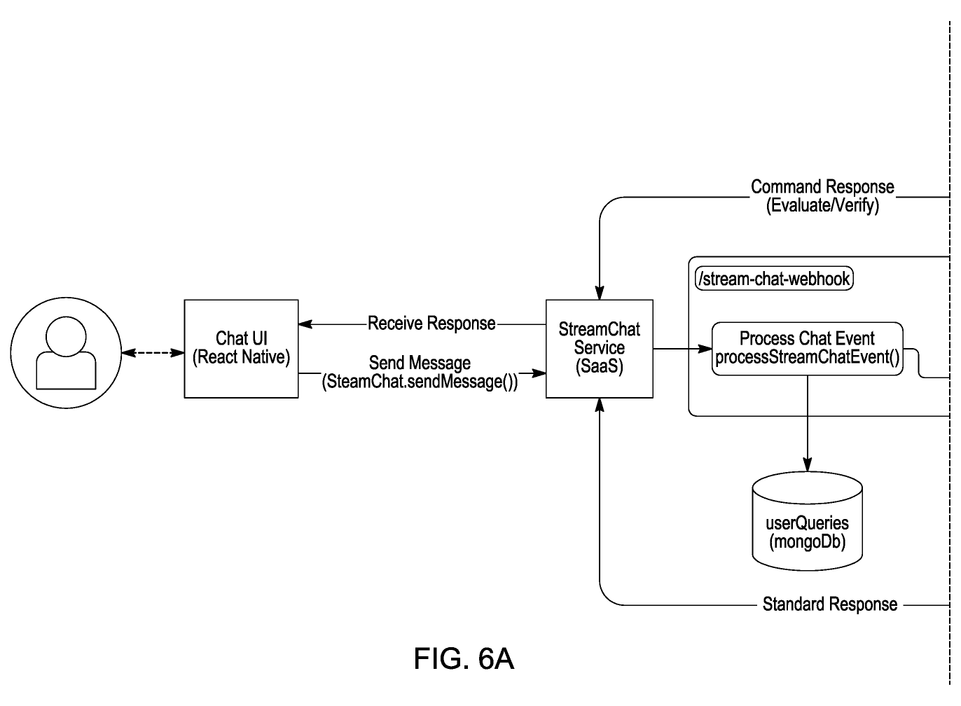

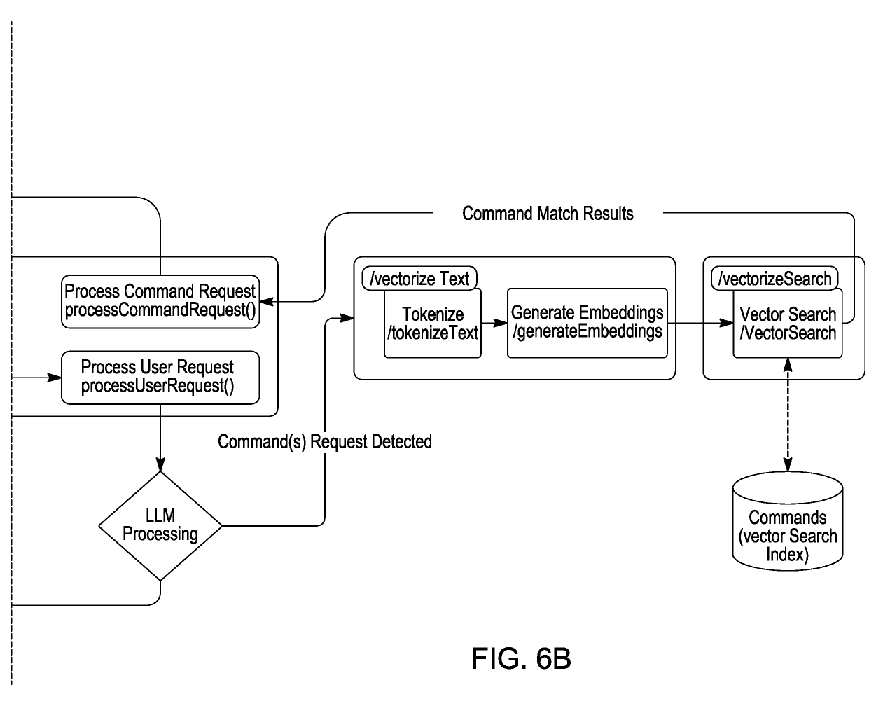

FIG. 6 (i.e., FIGS. 6A-6B combined) is a flow diagram illustrating an interaction process. The diagram is one example implementation of a runtime interaction flow. The process may begin with a user interacting with the chat user interface (e.g., by submitting a message via the interface). The message may be a task request or a message containing any other content.

The chat user interface (e.g., a REACT native application running on the user device) may submit the message to a platform-based “streamchat” service, which may handle the message. For example, the streamchat service may generate a chat event for processing of the message. In some cases, such processing may include format conversion (e.g., speech to text) or other pre-processing steps. Additionally or alternatively, the user query may be stored in a database (e.g., for later fine-tuning of the LLM), as shown in the flow diagram.

Next, the platform may process the user request to detect one or more task intents. This processing may involve generating a prompt for submission to an LLM. The prompt may instruct the LLM to identify one or more tasks intents that may be fulfilled by an API and to generate a plurality of data values for each detected task intent. The prompt may further include a description of the command schema (as described elsewhere herein) that may be used by the LLM to generate the data values. The prompt may further indicate that the LLM should indicate if no tasks intents are detected. In embodiments, one or more prompts including the above and/or other information may be generated and submitted to an LLM (e.g., either a remotely-hosted or local LLM). As shown in the diagram, the LLM may then process the prompt(s) and identify one or more task intents and associated data values (or that no task intent was identified). If no task was identified, the stream chat service may request the LLM to provide a response to the user message, which the platform may send back to the user for output via the user interface (e.g., as text, via text to speech, etc.).

If one or more task intents were identified by the LLM, the task intents and associated data values may be sent to a vectorization service 142, which may tokenize the text of data values generated by the LLM (e.g., the full command data value, the intent data value, the parameters data values, etc.) for each task intent. The vectorization function then may generate embeddings using the tokenized data values (e.g., using a local or remotely-hosted embeddings model).

After the embeddings have been generated, the platform may perform a vector search (e.g., using a vector search service 144) against the stored command data structures in the commands database. In embodiments, the platform may only search for commands that match enabled capabilities for the user. For example, if an “ecommerce” capability is disabled for a user, the platform may not perform a vector search of matching commands such as SHOPIFY API commands. In other words, the enabled capabilities may be used to filter the commands prior to the vector search. Additionally or alternatively, the enabled capabilities may be used to weight the commands retrieved via the vector search.

In some cases, the vector search may further include matching of keywords or other fields from an endpoint analysis data structure. The vector similarity search may detect matching command data structures based on the vector similarity (e.g., cosine similarity or another vector similarity function) of each data value generated by the LLM to the equivalent data value of the command data structure and/or related endpoint analysis data structures. For example, the LLM may have generated a first task intent with a full command data value of “get all customer data from HUBSPOT,” an intent of “get,” a resource of “customer data,” etc. The command database may store a command data structure with a full command data value indicating “retrieve customer information,” an intent of “retrieve,” a resource of “customer information,” a parameter of “all,” and/or other such matching data values. In addition, the stored command data structure may link to an endpoint analysis data structure with a keyword of “HUBSPOT.” Based on these similarities, the vector similarity search (plus optional keyword matching) may yield a strong match (e.g., because the embeddings of “get” and “retrieve” are very similar, etc.) and the corresponding API command may be selected as a command match.

In embodiments, multiple APIs may match a task intent (e.g., a task intent for booking a flight may match to several APIs), especially if a user has not specified a particular service or API provider. Accordingly, the vector search may return multiple matching results. In some cases, the vector search may return a top N matching results and/or the matching results that are above a similarity threshold. In some cases, the vector search may take into account user preferences or capabilities (e.g., by appending keywords to a vector search that indicate a user’s preferred or enabled service for a particular task) at search time. Additionally or alternatively, the user profile may be used after the vector search to refine a list of multiple matches (e.g., to select a recommended one of the matching API commands based on a user profile or preferences list).

The selection of APIs, calling of APIs, and other such processing may be performed by the platform as described elsewhere herein. The results of the vector search may be sent back to the user and provided to the user interface for verification, and then carried out by the platform as described elsewhere herein.

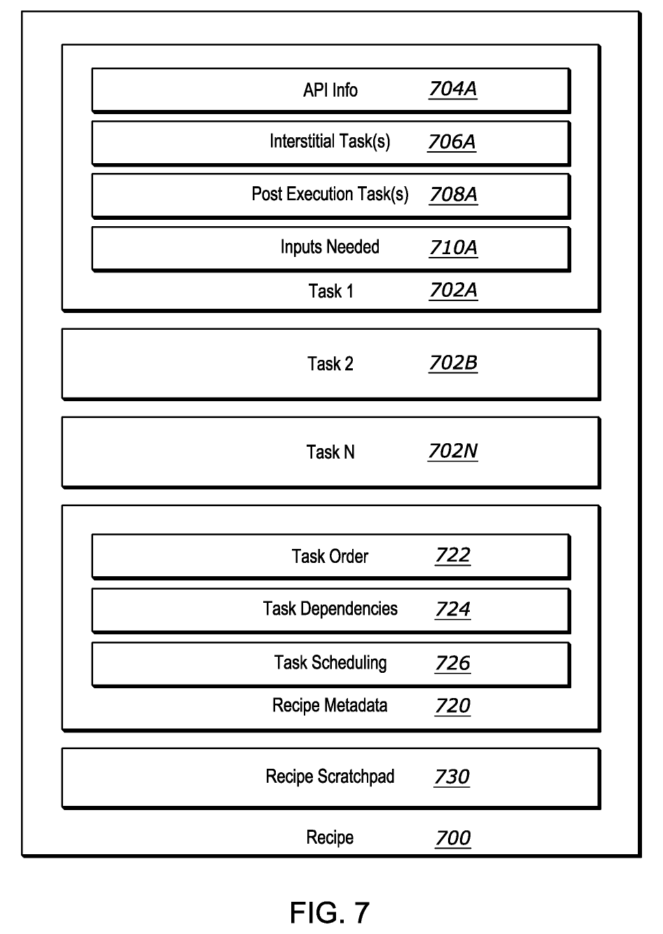

FIG. 7 illustrates an example data structure for a recipe 700. As illustrated, the recipe 700 may include several tasks 702A-N. The number of tasks may vary based on the recipe, which may be predefined (e.g., to perform certain common or repeatable sets of tasks) and/or generated on demand (e.g., in response to a user query). The generation of recipes on demand is described in more detail below.

In some embodiments, each task of the recipe (e.g., a first task 702A as depicted in FIG. 6A/6B) may include one or more subfields such as API info 704A, interstitial tasks 706A, post-execution tasks 708A, and/or inputs needed 710A. Each of these subfields and/or other subfields may be stored for each of the recipe tasks (e.g., a second task 702B, Nth task 702N, etc.). However, for the sake of convenience, the example subfields are only illustrated for the first task, task 702A.

The API info 704A may include API request information (e.g., an API request structured as a URL, JSON, and/or any other API request format), with relevant variables filled in to accomplish a desired task. In some cases, the API info 704A may include a fully prepared API request that is ready to be transmitted by the platform. Additionally or alternatively, the API request information may include blank or temporary values that may be filled in prior to calling the API (e.g., based on user-provided inputs specified by the inputs needed field 710A and/or based on information obtained from other tasks 702, interstitial tasks 706, and/or post execution tasks 708 of the recipe).

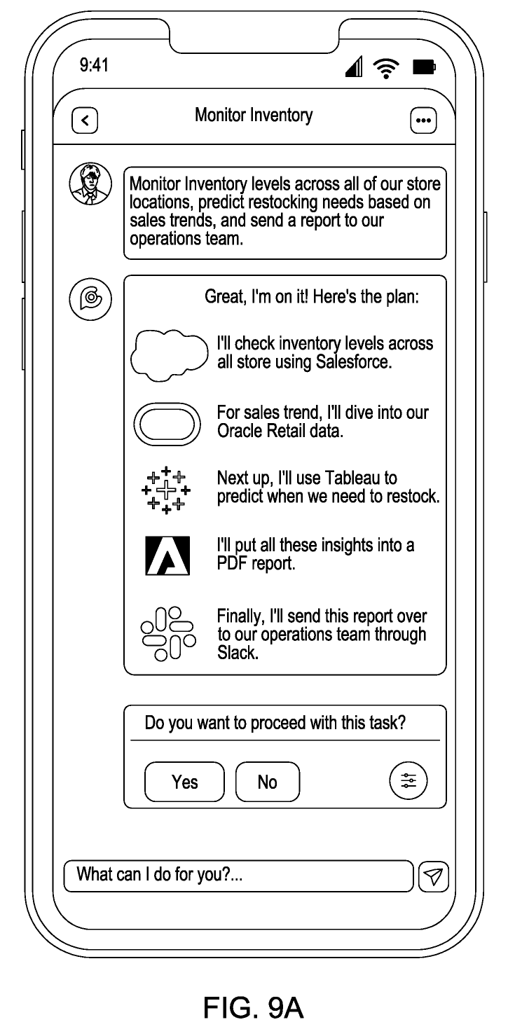

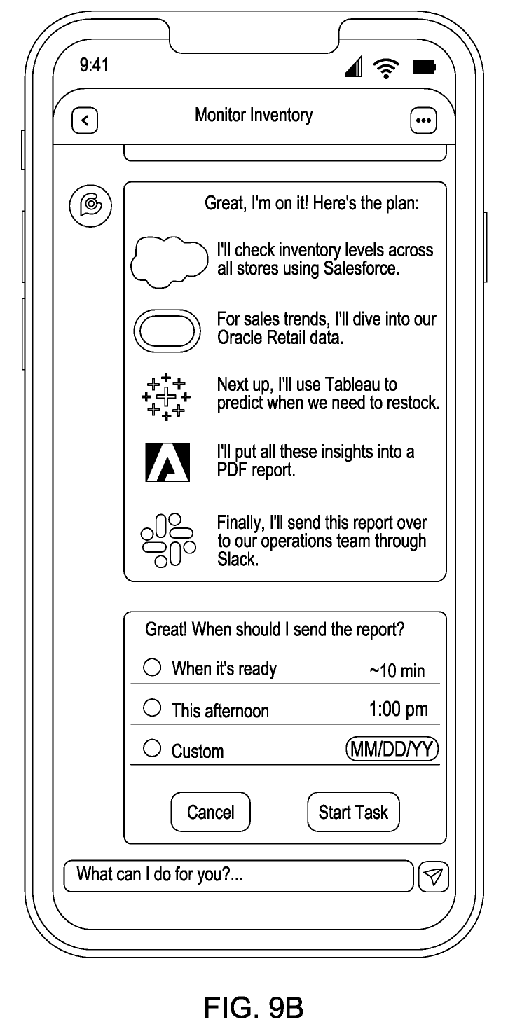

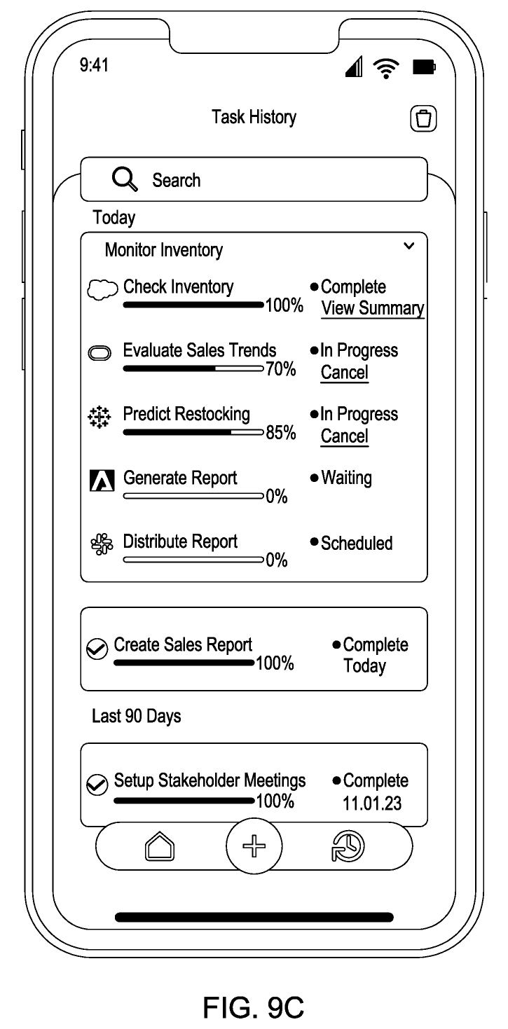

The API info 704A may further include other relevant information such as the name of the API, a logo of the API, a description of the API, etc. In embodiments, some or all of this data may be presented to a user via a user interface when previewing the recipe (e.g., as shown in FIG. 9).

In embodiments, a task 702 may include one or more interstitial tasks 706, which may define one or more ancillary tasks that the platform may execute (or cause to be executed by another device) prior to calling the API defined by the API information 704. For instance, an interstitial task may be a data gathering task that retrieves data that may be used to populate the API call. In this example, the interstitial task may include its own API call (which may be a same API or a different API compared to the one defined by the corresponding API info 704), may specify a local program, resource, data storage, or other tool running on the platform to generate or retrieve data, may specify a language model or other generative AI prompt that may be used by a language model or generative AI model to generate data, and/or the like. In other words, the interstitial tasks 706 may flexibly specify one or more tasks that may need to be performed prior to the API call, such as tasks that may be used to determine data values for the API call.

In embodiments, interstitial tasks may include data validation, formatting, transformation, aggregation, encryption/decryption and/or other such tasks, such as a task for validating/formatting data from a previous task or user input, transforming data from one form (e.g., unstructured text) or another (e.g., structured data fields), aggregation of data from multiple sources, encryption of sensitive data, and/or the like. In embodiments, the platform may leverage a large language model or other generative AI model to prepare data for an API call. For example, a user input or previous API call may include one or more sets of unstructured text or other data (e.g., an unstructured query describing what type of data is desired combined with unstructured text from another API call associated with a previous task), which the platform may process or cause to be processed (e.g., using a generative AI model) to generative structured data (e.g., various data filters, date limiters, and/or other query criteria) that is suitable for use in an API call. As a more specific example, if a task involves searching for hotels via an API, the platform may leverage a generative AI model to analyze a user input, user conversation history, user preferences, previous API responses, and/or other user information to determine which search parameters are already known (e.g., a user may have previously indicated, earlier in a chat conversation and/or in a previous task, their travel dates, and thus the platform may detect and format these dates for the API call via an interstitial task), and whether additional user input is required for any search parameters (e.g., a user may not yet have indicated a desired location and/or may have provided a vague location that requires additional clarification, which the platform may leverage a language model to detect and thereby seek additional user input). In embodiments, the result of an interstitial task may cause additional interstitial tasks to be generated. For example, if an interstitial task output (e.g., an API response, generative AI output, etc.) indicates that additional user input is required, the platform may prompt the user for the additional user input via a follow-up interstitial task. Although examples of interstitial tasks are provided herein, it should be understood that these examples of interstitial tasks are non-limiting, and the platform may perform any operations as interstitial tasks.

In embodiments, a task may also include one or more post-execution tasks 708A. Post execution tasks 708A may refer to ancillary tasks similar to interstitial tasks, but are performed by the platform (or caused to be performed by another device) after a response is received from the API. These tasks may involve storing some or all of the response data and/or processing some or all of the response data in some way, such as via another API call, using a language model or other generative AI model to process the data based on a prompt, or using a local analysis tool or other program running on the platform to process the data. Additionally or alternatively, the post-execution tasks may include data parsing, response validation, error logging, generating and/or transmitting a notification, and/or the like. Additionally or alternatively, post-execution tasks may include any of the interstitial tasks described above. In embodiments, the platform may leverage a language model or other generative AI model to perform a post-execution task. In embodiments, the result of a post-execution task may cause additional post-execution tasks to be generated. For example, if a post-execution task output (e.g., an API response, generative AI output, etc.) indicates that additional processing is required (e.g., if summarization and/or aggregation of data returned via an API call is needed), the platform may further process the data via a follow-up post-execution task.

In embodiments in which interstitial tasks and/or post-execution tasks include an API call, the relevant fields 706/708 may include similar API information as defined in the API info 706 (e.g., an API request, etc.). Additionally or alternatively, if the interstitial tasks and/or post-execution tasks leverage a language model or other generative AI model, the relevant recipe data 706/708 may store a prompt for requesting performance of the task by the language model or generative AI model. For example, if the platform leverages a generative AI model to translate text from one language to another (e.g., because the user speaks one language but the platform is calling an API that provides data in a different language), the interstitial tasks and/or post-execution tasks may include data translation tasks via a generative AI model, and therefore a prompt may indicate which language the generative AI model should translate to and/or from. Additionally or alternatively, if the interstitial tasks and/or post-execution tasks leverage a local program or other tool, the relevant recipe data 706/708 may include a location of the tool (e.g., filename/filepath/function) and/or other information for using the tool.

The inputs needed field 710A can indicate one or more requirements for further input from the user. For instance, if the task involves calling an API to search for and/or reserve an item such as a hotel room, a car, or a flight, the user may need to provide certain information such as a date and time, price range, etc. Accordingly, the inputs needed field 710 can specify that the platform should obtain certain information, such as prompting a user for the certain information, prior to transmitting an API request and invoking the API endpoint.

The recipe 700 may also define recipe metadata 720, which include a task order 722, task dependencies 724, and/or task scheduling 726. The task order 722 may indicate the sequence in which the tasks are to be performed by the platform. The metadata may further include task dependencies 724, which may indicate whether certain tasks need to be performed prior to other tasks or any other similar dependencies. For example, some tasks may be independent of each other and therefore can be performed in parallel by the platform (e.g., two separate tasks to gather data from two separate data sources). For other tasks, an output of one task (e.g., API response data) may be needed to generate data for an API request for another task, and therefore dependencies 724 can indicate that certain tasks must be performed sequentially so that a second task can use data from a first task. Additionally or alternatively, task dependencies 724 may indicate conditional logic relationships, such as if-then, if-then-else, looping behaviors, or other relationships between tasks. For example, the task dependencies 724 may indicate that the platform should perform a particular task only if another particular tasks fails. As another example, the performance of a task may be conditional on any other aspect of an API response and/or ancillary task, such as a certain status code or other value in an API response.

In some embodiments, the metadata can further include task scheduling 726, which may indicate when tasks should be performed (e.g., immediately, within a certain time period, at a certain date/time, etc.). In embodiments, task scheduling 726 may indicate repeaters, for example that a task or series of tasks should be performed every day, every week, every other Tuesday, etc.

In embodiments, a recipe data structure 700 may further include one or more recipe logs 730 that may be used to store data that is generated when executing the recipe. For example, the recipe log(s) 730 may store API responses, results of interstitial tasks, results of post execution tasks, etc. In embodiments, a recipe 700 may be associated with multiple logs 730, each of which may correspond to an execution of that recipe. In these embodiments, the platform may generate and store in the log 730 one or more first variables for a first API response and/or various sub-fields thereof, one or more second variables for a second API response and/or various sub-fields thereof, and so on. Likewise, the platform may generate and store variables for the outputs of any interstitial tasks and/or post-execution tasks. In these embodiments, the logs 730 may store data variables and associated values that are generated by APIs and/or processing tools.

In some embodiments, as discussed in more detail below, the platform may use a “scratchpad” to store “intermediate” data generated by a language model for use by the language model. For example, the platform may provide one or more language model prompt(s) that instruct the language model to process data in several steps and indicate the output of each step in a “scratchpad” in order to provide better results. In embodiments, the intermediate data and/or other data generated by the language model (e.g., prompts and/or responses) may be stored in the recipe logs 730 as a record of the operation of the language model when executing the recipe.

Accordingly, it will be appreciated that the recipe 700 data structure allows for a flexible recipe definition that may cause the platform to execute various sets of tasks, which include multiple API calls and/or ancillary tasks, to carry out diverse workflows based on the individual requirements of each workflow.

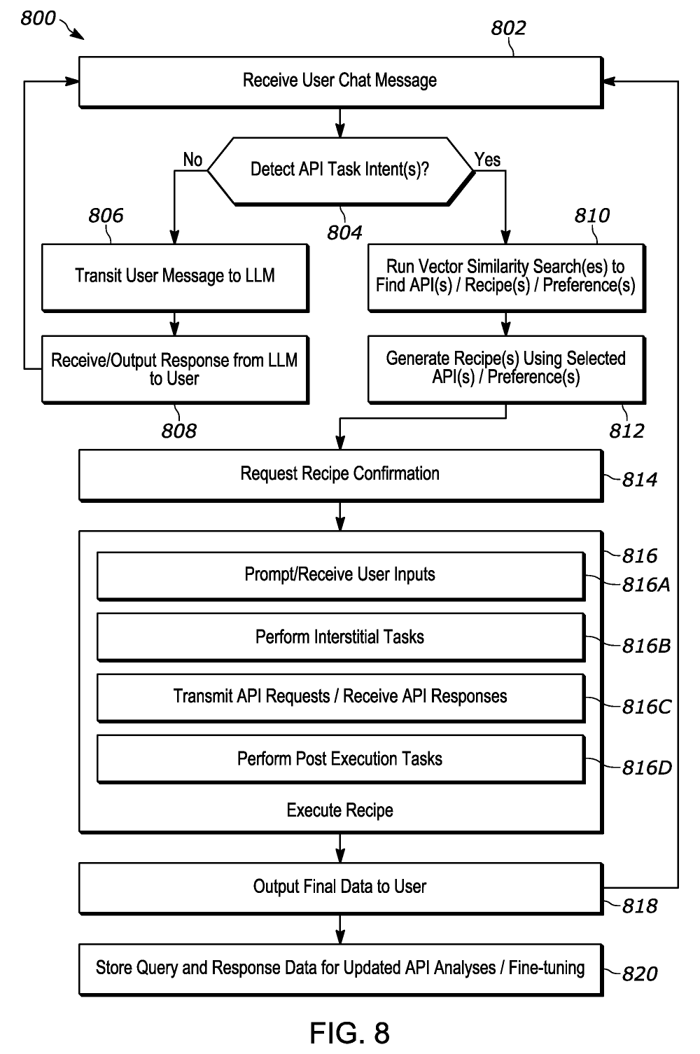

FIG. 8 illustrates a method 800 that may be used by a platform at runtime as described herein for providing an API-enabled chat interface to users.

At step 802, the platform may receive a user chat message. The platform may receive the user's request via the chatbot user interface module. The user’s request may be textual, voice, multimodal, and/or any other form of input. The chat message may be part of an ongoing conversation that may include initial requests, follow-ups, feedback, requests for clarification, and/or the like.

At step 804, the platform may determine whether the user chat message includes an “API task intent” that may be best satisfied via an API call. The platform may use an LLM and/or natural language processing algorithms for this purpose. For example, the platform may provide the chat message to an LLM as part of a prompt that instructs the LLM to analyze the chat message and to detect whether there are one or more task intents that may be handled by an API. In embodiments, the prompt may further include a command schema (e.g., the same command schema described above, including an intent field, a parameters field, a resource field, etc.) and request that the LLM format fill in any relevant data values based on the one or more detected tasks (e.g., an intent value, a resource value, one or more parameter values, etc.). In response, the LLM may respond with a list of one or more tasks and associated data values (e.g., intent, resources, parameters, etc.) and/or an indication that no task intents are detected. Depending on the response, the platform may proceed to step 806 or to step 810.

At the branch starting at step 806 (e.g., if the platform did not detect an API intent at 804), the platform may transmit the user chat message to the LLM. The prompt may include the user chat message as well as the conversation history for a corresponding conversation so that the LLM may reply to the user chat message in the context of an ongoing conversation.

At step 808, the platform may receive the LLM’s response to the user chat message and output it back to the user. For example, it may be displayed on a user interface or otherwise output via a user device. The process may then loop back to step 802 if/when a user responds with a follow-up message.

At the branch starting at step 810 (e.g., if the platform did detect at least one API task intent at 804), the platform may run a vector similarity search to find relevant API commands for each of the one or more API task intents. Additionally or alternatively, the platform may, in some cases, find a pre-generated recipe that matches the one or more API task intents. In other words, if a pre-generated recipe already describes a workflow for a set of one or more API task intents, the platform may identify the pre-generated recipe; but if no pre-generated recipe exists, the platform may find a set of matching API commands that may be assembled into a recipe.

If multiple task intents were detected at step 804, the platform may take a first task intent, tokenize the various data fields, generate a plurality of embeddings for the various data fields of the task intent (e.g., a full command data field, an intent data field, a resource data field, parameters data field(s), etc.), and use the embeddings to perform a vector similarity search to find one or more best-matching command data structures. The platform may generate the embeddings by submitting the tokenized data fields to an embeddings model. The vector similarity search may involve comparing the embeddings to embeddings of the same or similar data fields from various data structures generated by the contextual analysis of an API. For example, the embeddings may be compared to embeddings of data fields of a command data structure and/or embeddings of keywords from a corresponding endpoint analysis data structure.

Additionally or alternatively, the platform may use a vector similarity search to compare the task embeddings generated based on the user request to embeddings that correspond to one or more predefined API recipes. In other words, in addition to or as an alternative to searching for matching API commands, the platform may directly search for API recipes that define sequences of API calls, LLM processing, and/or other operations for retrieving data from a first set of APIs, optionally processing the data, submitting at least some of the data to a second set of APIs, etc. In these embodiments, the recipes may be stored in associating with a set of data fields and associated embeddings, where the recipe data fields may be the same as or different than the command and/or endpoint analysis data fields described elsewhere herein. In some cases, the recipes may have multiple data fields of the same type (e.g., multiple intent fields recording different intents for multiple steps performed by the recipe, multiple parameter fields recording the parameters for each step, etc.).

The platform may select one or more API commands and/or recipes based on the vector similarity search. In embodiments, the platform may also leverage user preference data to refine the selection of API commands and/or recipes. These user preferences may include, but are not limited to, a type of user device (e.g., an operating system and/or form factor), preferred applications or services (e.g., installed applications, lists of services for which the user has a subscription or other credentials, etc.), enabled capabilities (e.g., as described above), and/or the other user preference data described elsewhere herein. In embodiments, may be stored and maintained in a user profile associated with each user. For example, the platform may query a user profile database or other data storage system using an identifier associated with the user (e.g., a user ID, username, device ID, etc.) to retrieve user preference data. In embodiments, the platform may use retrieval augmented generation (RAG) techniques to retrieve relevant user preference data based on the user request. If using RAG techniques, the platform may query the user preferences that are relevant based on a second vector similarity search (e.g., such that only preferences that are relevant to the user query are retrieved). In these embodiments, embeddings for the user preference data may be stored in the user database and/or generated on-the-fly using an embeddings model, and the platform may compare the embeddings for the user preferences to the embeddings for the user query to determine which user preferences are relevant. Additionally or alternatively, the user preference data may be used to filter and/or weight the results of the first vector similarity search that compares the embeddings generated based on the user request to the embeddings that correspond to one or more predefined API recipes and/or commands.

In embodiments, the platform may use additional metadata to relate the user preference data to the command or recipe embeddings. For example, if the user preference data indicates the user is using a particular device, the platform may use metadata about the compatibility of each API with different devices to filter the user preference data and/or API command data.

In some embodiments, the platform may detect (e.g., prior to performing the vector similarity search of step 810) that the user query corresponds to a disabled capability. For example, if a user query requests that the platform create an ecommerce site for the user (e.g., which may be detected at step 804 as an API task intent), but the user’s personalized capabilities indicate that ecommerce is disabled, then the platform may cause display of a user interface (e.g., on the user device) requesting the user to enable ecommerce. In embodiments, the user interface may request that the user enable multiple capabilities. For example, if the user query was “set up an ecommerce site with analytics”, and the platform detects that both the ecommerce and analytics capabilities are not enabled for the user, the platform may generate and cause display of a user interface requesting the user to enable both ecommerce and analytics capabilities. In embodiments, the user interface may further allow the user to indicate preferred API providers (e.g., the user interface may indicate multiple API providers such as SHOPIFY and WOO COMMERCE for the ecommerce capability and allow the user to pick one or more of the multiple API providers). In response to the user inputs of the user interface, the platform may update the user's capabilities and/or preferences to enable the indicated capabilities and/or store the preferred API providers.

In embodiments, the platform may determine that a particular requested capability has not yet been onboarded by the platform. For example, the platform may not yet have crawled and/or analyzed ecommerce sites to ingest API data for ecommerce providers. Additionally or alternatively, the platform may not yet have ingested API data for a particular API provider (e.g., if a user request is “set up a SHOPIFY site” but the platform has not yet analyzed the SHOPIFY API). In these cases, the platform may execute some or all of the steps of the methods 400 and/or 450 of FIGS. 4A-B as appropriate. For example, if a capability has not yet been onboarded, the platform may execute the method 400 to find, analyze, and onboard several API providers for the new capability. If the platform cannot find API documentation, the platform may use the method 450 of FIG. 4B. Additionally or alternatively, if a particular API provider (e.g., an API provider specifically requested in a user query) has not yet been onboarded, the platform may execute the methods 400 and/or 450 of FIGS. 4A-B to analyze and onboard the requested API provider. In embodiments, the platform may indicate that the platform is performing a one-time onboarding process for the user. In these embodiments, the platform may indicate a progress bar, estimated time to completion, and/or instruct the user to try again at a later time after onboarding completes. As described above, once a capability and/or API provider has been ingested for one user, it may be available for use by other users as well. Thus, the set of capabilities and API providers for the platform may grow over time.

At step 812, the platform may generate a recipe on the fly based on the one or more selected API commands (e.g., if no pre-generated recipes was found). In embodiments, the platform may retrieve API command data for each selected command for use in generating the recipe. Additionally or alternatively, the platform may use relevant preference data (which may be retrieved based on the user query and/or other user context data as described above, and/or may have been entered by the user already as described above) to filter or select the one or more API commands. In embodiments, the platform may leverage a language model or other generative AI model to select the best API commands for a recipe. For example, the platform may transmit a prompt to a generative AI model that specifies the user query, the matching list of APIs (e.g., that were retrieved via a first vector similarity search that compares the user query embeddings to the API command embeddings), and the list of user preferences (e.g., that were retrieved via a second vector similarity search that compares the user query embeddings to the user preference embeddings). The generative AI model may then respond with the selected API commands that best match the user query and user preferences.

In embodiments, the platform may leverage the language model or other generative AI model to generate an entire recipe data structure 700 that defines tasks 702 using relevant APIs based on the user query and/or user preference data. In embodiments, the platform may provide one or more prompts to the generative AI model that instruct the generative AI model to select the best API commands and generate a recipe therefrom. In these embodiments, the platform may provide the generative AI model with a prompt that instructs the model to output a recipe data structure including one or more of fields 702-730 of the recipe data structure 700, each of which may be specified in the prompt. The fields may include, for example, one or more API info fields, such as an API request field, one or more interstitial tasks fields, one or more post execution task fields, and/or one or more inputs needed field. The fields may further include task order field(s), task dependencies field(s), and/or scheduling field(s). The prompt may further specify what type of data should be included in each field. For example, the prompt may indicate that the model should output any necessary interstitial tasks using a text string, should output any inputs needed by indicating the type of data needed (e.g., numeric, date, text string, etc.) and a name of the field, etc. The platform may further include the API command information (e.g., including any or all of the above-described fields) for each of the selected one or more APIs within the prompt so that the generative AI model may use the API command information to fill in the recipe data fields.

As a specific example, the platform may receive a user query such as “provide me with a one-week vacation opportunity sometime in November, in a location that has an average November mean temperature above 60 degrees Fahrenheit, staying in a hotel that is pet friendly within a walkable distance to an art museum, for a cost under US $X…” at step 802. The platform may detect multiple API task intents at step 804, and may run a vector similarity search to find relevant API commands at step 810. The list of API commands retrieved at step 810 may be include numerous API commands, such as multiple travel APIs, multiple hotel information APIs, hotel booking APIs, flight search APIs, flight booking APIs, business information APIs, weather APIs, and/or the like. The platform may further run a second vector similarity search to retrieve relevant user preferences, such as a user’s preferred airline, preferred booking service, account information associated with these services, places the user has previously travelled, type of pets, and/or any other such data in the user preference profile. Then, at step 812, the platform may transmit a prompt including the list of relevant API commands and relevant user preferences to a generative AI model. The prompt may further specify the recipe data structure, including each required data field, the type of data that should be provided in each required data field, etc., and may instruct the generative AI model to output a populated recipe including one or more tasks (which the generative AI model may generate based on the provided list of API commands and/or according to any relevant user preferences). Accordingly, the generative AI model may output a recipe 700 with some or all of the populated data fields described above.

Accordingly, the platform may use the output of the generative AI model to populate the various fields of the recipe 700, thereby yielding a recipe 700 with several tasks 702, where each task 702 includes populated API info 704 (which may be derived from the API command information as well as other contextual information such as a conversation history), populated interstitial tasks 706 (which may be derived from the API command information that indicates what type of data is needed for an API request and/or other contextual information), post execution tasks 708 (which may be derived from the API command information that indicates what type of data is returned in an API response, what type of data is needed for a subsequent API command and/or for output to a user, and/or other contextual information), inputs needed 710 (which may be derived from the API command information indicating what type of data is needed for the API request and/or other contextual information), populated recipe metadata 720 such as a task order 722, task dependencies 724, and task scheduling 726 (which may be derived from the API command information for the individual tasks, overall goal of the user query, and/or other contextual information).

In some embodiments, the platform may use one or multiple generative AI prompts to generate the recipe 700. For example, the platform may transmit a first prompt including the matching API commands and relevant user preferences in order to cause the generative AI model to select the best APIs for the recipe, then transmit a second prompt including contextual API information (e.g., any of the information described elsewhere herein) and a schema of the recipe data structure 700 in order to cause the generative AI model to generative the recipe 700. Additionally or alternatively, the platform may transmit all of the above data in a single prompt that requests the generative AI model to output a populated recipe 700. Additionally or alternatively, the platform may asynchronously transmit a single prompt to generate a portion of the recipe 700 corresponding to each task 702 (e.g., to speed up generation of the recipe 700).At step 814, the platform may request confirmation of the API commands and/or any other aspect of the generated recipe(s). For example, it may display a user interface requesting the user to confirm which of the commands to run, to select one of several recipes, edit the recipe (e.g., by selecting a different API to perform a particular task), and/or the like. Example user interfaces are shown below with respect to FIGS. 9A-C.

In embodiments, at step 814 a user may select an alternate API for a particular function. For example, if a recipe includes a task to search for a hotel using a particular API (e.g., KAYAK), but the user prefers to use a different API for the same task (e.g., EXPEDIA), the user may select an option to change the selected API into the user’s preferred API. In these embodiments, the platform may generate a user interface that shows the default selected API provider (e.g., KAYAK) and a function that allows the user to change the selected API provider. For example, the user interface may provide a drop-down menu of alternative API providers for a given task. To generate the drop-down menu, the platform may select the top-ranked APIs for a given task (e.g., according to the first vector search described above) and populate a user interface functions that allows the user to select which the top-ranked APIs should be used to complete a particular task. For example, the platform may select the top-N ranked APIs, the APIs that score above a threshold similarity score via the vector search, the APIs that match user preferences, and/or the like. The platform may then transmit the configured user interface (e.g., including the list of potential APIs for a task, including the selected default API) to the user for confirmation of the selected API and/or for the user to select an alternate API.

In embodiments, at step 814 the user may adjust one or more selected parameter(s) or other data fields for a given task. For example, if the platform detected that a user is looking to book hotels between two particular dates (e.g., based on the user’s conversation history), the user interface may indicate that one of the tasks is to search for hotels for a stay spanning the two particular dates. In this example, the user interface may be configured to allow a user to adjust the dates (e.g., if a user changes their mind on the dates). In other words, various aspects of the recipe (including selected APIs, parameters, other data fields, etc.) may be editable by the user prior to executing the recipe. Any recipe data fields, including any of the parameters and/or other data fields described elsewhere herein, may be editable in this manner.

In embodiments, at step 814 the user may view and/or adjust the interstitial tasks and/or post-execution tasks. In embodiments, the platform may normally keep the interstitial tasks and post-execution tasks hidden from a user when displaying a recipe (e.g., in order to focus the user’s attention on the most important aspects of the recipe, rather than the ancillary tasks). However, the platform may generate a user interface that includes a function that allows a user to view and/or edit the interstitial tasks and/or post-execution tasks. Such a function may allow users greater control over recipe configuration and execution.

At step 816, the platform may execute the recipe, which may include transmitting one or more API request(s) and receiving one or more API response(s) as defined by a recipe (e.g., either a pre-generated recipe or a recipe generated at step 812). Execution of the recipe may include several sub-steps 816A-D, which may be performed in any order for each task 702 of a recipe 700.

At 816A, the platform may begin executing a particular task 702 by prompting for and receiving user inputs as defined by the inputs needed field 710 of the corresponding task 702. For example, the platform may prompt the user for additional input in scenarios where the task requires more data than what is currently available to the system. For instance, as described above, when searching for and/or booking an item like a hotel room, a car, or a flight, the user may need to provide certain information such as a date and time or other user-specific preferences. The platform may accordingly prompt the user for the inputs specified by the inputs needed field 710 of the recipe. Additionally or alternatively, in some cases the desired inputs may be detectable from prior user messages, a conversation history, and/or user preferences associated with a profile. For example, a prior message in the user conversation history may have specified the user’s preferred travel dates, and the platform may leverage a language model (or other generative AI model) to determine whether a user input is actually needed or not based on contextual factors prior to prompting the user for input. Additionally or alternatively, the platform may prompt a user to confirm a detected value. Additionally or alternatively, the platform may generate a guess value (e.g., using the language model or other generative AI model) based on conversation history, user preferences, etc., and prompt the user to confirm or edit the guess value. In this way, the platform may provide assistance to a user by leveraging a generative AI model and any contextual information, while still enabling the user to confirm the correctness of a value prior to executing a task.

In some embodiments, steps 814 and 816A may be combined, such that a user may review/confirm/edit a recipe and provide user inputs at the same time. In other words, the platform may provide a single user interface that allows a user to adjust a recipe (e.g., by changing an API, changing a selected parameter) as well as to provide other user inputs (e.g., any parameter or other data that the platform identifies as a user input).

At 816B, the platform may perform one or more interstitial tasks 706 for the current task 702. As described above, the interstitial tasks 706 may involve data gathering, data processing, or other pre-API call operations that may be useful prior to transmitting an API request. For example, the system may need to gather data from a user or from an external source to populate the API call. Each interstitial task may have its own associated API call, or it could involve using a local program to generate or retrieve data. In embodiments, the platform performs interstitial tasks to ensure that all the prerequisites for the API call are met. In these embodiments, if one of the interstitial tasks fails (e.g., an interstitial task includes an API call that returns an error), the platform may leverage a language model or other generative AI model to generate a substitute interstitial task (e.g., accessing an alternate tool or data source) for fulfilling any prerequisites of a task using an alternate strategy.

At 816C, the platform may format and transmit an API request for a task as defined by the API info 704 for a task. In embodiments, the API request may be populated by data received via inputs at 816A and/or data retrieved or generated via interstitial tasks 816B. Additionally or alternatively, some of the data fields for the API request may be generated by the platform via a language model or other generative AI model, as described above. The platform may receive a response from a third-party API provider in response to the API request. The API request may use any available API format and may include data fields containing relevant information.

At 816D, the platform may perform one or more post-execution tasks 710 for the current task 702. The post-execution tasks may involve processing the data received from the API in various ways, for example for presentation to a user, for use in another API call (e.g., for a subsequent task of the recipe 700), and/or for any other reason. As above for step 816B, the platform may perform post-execution tasks that may comprise another API call, may use a language model or other generative AI model to process API response data based on a prompt requesting a specific type of processing (e.g., summarizing or the like), may use a local tool running on the platform, and/or may otherwise process API response data.

The platform may repeat one or more of the sub-steps 816A-D for each of the tasks 702 of the recipe. In some embodiments, the platform may execute multiple tasks in parallel, and thus the platform may be executing multiple of the sub-steps 816A-D (e.g., for different tasks 702 and/or the same task 702) at any given time. Additionally or alternatively, the platform may execute one or more of the sub-steps 816A-D for a first task 702, then execute one or more of the sub-steps 816A-D for a second task 702, etc., thereby sequentially executing the tasks 702 of a recipe 700. In embodiments, the platform may prompt the user for user inputs for all of the recipe tasks 702 at the same time. In other words, step 816A may be performed simultaneously for a first task, a second task, and a third task (for an example recipe with three tasks), with a user inputting all necessary inputs for each of the three tasks prior to the platform performing the remaining sub-steps for each task (which may occur in parallel, sequentially, etc.). In embodiments, the platform may use conditional logic to decide whether to execute a given task. For example, if a first task fails (e.g., because an API call returns an error), the platform may try a second task that is only executed if the first task fails. As another example, if a first task yields a certain result (e.g., an API response indicates a particular status or condition), the platform may perform a second task that is executed based on the particular status or condition. In this example recipe, if the first task had yielded a different status or condition, the recipe may have indicated that the platform execute a third task based on the different status or condition. In this way, the use of recipes by the platform may allow for flexible and complex workflows.

In embodiments, any of the data generated by the various sub-steps 816A-D may be stored in the recipe log 730 (e.g., for use by later sub-steps, for outputting to a user or other tools, etc.) and/or in some other data structure. Additionally or alternatively, the platform may store notes in the log 730 that indicate, for example, any errors detected when calling particular APIs with certain parameters or other data, failures during recipe execution and/or how the failure were resolved or routed around, and/or other such notes for improving future executions of the same recipe. In embodiments, the platform may leverage the language model or other generative AI model to generate notes for long-term storage in the log 730.

At step 818, the platform may output final data to the user. The final data may include any of the data received from API(s) and/or generated by the LLM or other generative AI model via the various sub-steps 816A-D of step 816, status of tasks (e.g., an indication that some or all of the tasks were completed successfully, had errors, etc.), and/or any other information about the execution of the recipe. The process may then loop back to 802 so that the user may continue a chat conversation, request additional workflows, request further processing of the data output at step 818, and/or the like.

At step 820 (which may occur asynchronously after step 818, at regular intervals, in response to a specific condition, etc.) the platform may store query and response data that may be used for updating API analyses and/or fine-tuning models at a later time. In embodiments, the platform uses a conversation history (e.g., a series of user queries or other user inputs and corresponding responses by the platform) for fine-tuning one or more generative AI models. Additionally or alternatively, the platform may use any user inputs and/or user feedback provided by the user. For example, if a user edits a recipe (e.g., to swap out an API selected by the platform for another API), the user edits may be used as feedback for the fine-tuning. Additionally or alternatively, if the platform requests user inputs as described above, the platform may use the provided user inputs for the fine-tuning. Additionally or alternatively, the platform may use log 730 data and/or other data (e.g., intermediate data, API request data, API response data, any data generated by a language model, any data generated by any other tool used during execution of the recipe, and/or other data generated during execution of the recipe) for fine-tuning. In some embodiments, the platform may fine-tune the generative AI model using any feedback provided by the user and/or any actions taken by the user in response to the task being performed. For example, if in response to the user booking a flight identified by the platform during a task, the platform may treat the user’s booking of the flight as positive feedback as the user has validated the generative model’s task execution. In this example, the platform may fine tune the generative AI model using the user’s initial query, the generative AI model’s output in response to the initial query, and the positive feedback data. If, however, the user provides negative feedback (e.g., clarification from the user that they were looking to book a hotel), the platform may use the negative feedback to fine tune the model.

The platform may use various fine-tuning methods to optimize the one or more generative AI models using the various fine-tuning data. In embodiments, the platform may use any of the various fine-tuning data as additional training data (e.g., to further pre-train the generative model). Additionally or alternatively, the platform may use reinforcement learning using human feedback (RLHF) based on human/user feedback (e.g., human feedback rating outputs of the language model as helpful / not helpful, human feedback indicating that one language model output was more helpful than other language model responses, etc.). In these embodiments, the platform may use a reward model that is created based on the human-generated comparisons between the responses. Additionally or alternatively, the platform may use other models (e.g., in place of humans) to generate the comparison data for the reward model (e.g., reinforcement learning using AI feedback (RLAIF)). In RLHF and/or RLAIF embodiments, the platform may then use proximal policy optimization to fine-tune the model(s) using the reward model.

FIGS. 9A-C illustrate example user interfaces that may be used by a user to confirm a selection of a multi-step plan (e.g., an API recipe) involving the use of multiple APIs as described herein. As shown in the FIG. 9A, a user has input the example query “Monitor inventory levels across all of our store locations, predict restocking needs based on sales trends, and send a report to our operations team.” In response, the platform identifies five (5) APIs and/or software functions to carry out the requested query. As shown in FIG. 9A, the platform identified the SALESFORCE API for checking inventory levels, the ORACLE Retail API for determining sales trends, the TABLEAU API for predicting restocking needs, ADOBE for generating an PDF (e.g., using an ADOBE API and/or a local script), and a SLACK API for sending the report to the operations team. In embodiments, this multi-step recipe may have been pre-generated and/or may be generated on the fly by the LLM, and may include various interstitial tasks and/or post-execution tasks that may include LLM or other processing (not shown to the user) such as generating analyses based on the data retrieved from SALESFORCE, ORACLE, and/or TABLEAU. The FIG. 9A user interface further illustrates that the user may approve the plan before execution. Additionally or alternatively, in some embodiments a user may be able to provide any necessary inputs, edit the plan (e.g., including interstitial and/or post-execution tasks), remove steps (e.g., including interstitial and/or post-execution tasks), request a new plan, submit a new query, and/or the like. For example, the user may decide to send the report via email (instead of or in addition to SLACK). In this example, the user may click on the fifth step to edit it and/or type a new query indicating that the user prefers email. Other similar changes may be handled in similar ways.

FIG. 9B illustrates that a user may provide scheduling information, such as a time for completing a task (e.g., when a report will be sent). In embodiments, the platform may request the user to verify parameters or other options when the platform is unsure of that parameters or other options and/or in other cases, such as for scheduling purposes as illustrated. It is appreciated that the platform may be configured to suggest times to the user for one or more considerations. For example, the platform may suggest times to the user that would allow the platform to manage the availability of the generative AI model and/or reduce costs (e.g., sending requests to the generative AI model at non-peak times). In another example, the platform may suggest times to the user that comport to certain expectations (e.g., scheduling work-related messages to be sent during business hours) and/or user preferences.

FIG. 9C illustrates a progress screen indicating a current progress of the API calls, LLM processing, and/or the like. The platform may update the screen in real-time to indicate the current progress of the task. A user may also refer to the progress screen to retrieve past task results, initiate new tasks, and/or the like.

The following example use cases are illustrative of various uses of the application. They should be taken as exemplary and non-limiting use cases that are enabled by the features and functionalities described herein. Each of the following examples in quotations are examples of plain English (natural language) commands that may be generated by the application and mapped to APIs/recipes during API analysis and/or are examples of user inputs (e.g., chat messages) that may be received from users and used to find matching APIs/recipes.

### Healthcare Use Cases

"Scan patient feedback to identify common complaints, analyze trends over the past six months, and suggest potential areas of service improvement." For this example use case, the platform may retrieve patient feedback via a first API (e.g., for a customer database or related service), leverage an LLM to identify common complaints, leverage a second API to analyze trends (e.g., via a data analysis service), and leverage an LLM to suggest potential areas of service improvement based on the second API analysis.

"Integrate patient health data from various devices, analyze for anomalies, send alerts to medical professionals if irregularities are detected, and schedule follow-up appointments." For this example use case, the platform may use a first (set of) API(s) to gather patient health data from multiple devices (e.g., heart rate monitors, glucose meters, databases, etc.), then the platform may use an LLM and/or another API (e.g., a data analysis API) to analyze this data for any anomalies. If any irregularities are detected, the platform may send alerts to the appropriate medical professionals (e.g., through a healthcare messaging service API). The platform may then use the LLM to generate a follow-up appointment schedule based on the severity and nature of the detected irregularities, and use another scheduling API to interface with a healthcare scheduling system.

"Track medicine inventory levels in real-time, automatically reorder supplies when low, and notify the pharmacy team of expected delivery dates." For this example use case, the platform may use a first API to periodically monitor medicine inventory levels (e.g., through an inventory management API). If supplies are low, the platform may use an LLM to determine the appropriate quantity to reorder (e.g., based on usage trends and/or current stock level data, which may be provided by the same API and/or another API). The platform may then leverage another API to automatically place an order for the required supplies (e.g., through a pharmacy supplier API). Once the order has been placed, the LLM may estimate expected delivery dates and use another API to notify the pharmacy team of these dates (e.g., through a team communication or project management API).

"Analyze recent research and medical publications, summarize findings relevant to a particular specialty, and distribute weekly digests to corresponding medical teams." For this example use case, the platform may use a first (set of) API(s) to gather recent research and medical publications from various sources (e.g., medical databases, online journals, etc.). The platform may then use an LLM to analyze this information, identify findings relevant to a specific medical specialty, and generate concise summaries of these findings. The platform may then use another LLM to compile these summaries into a formatted weekly digest (e.g., a PDF generation API) and then use another API (e.g., an email service API) to distribute these digests to the corresponding medical teams on a weekly basis.

### Real Estate Use Cases

"Identify properties in a city that match a specific set of criteria, schedule virtual tours for potential clients, and send them a portfolio with property details." For this example use case, the platform may use a first (set of) API(s) to retrieve property data from various real estate databases, where the API calls specify filters for at least some of the criteria. In some cases, the platform may then use an LLM to further filter and identify properties (e.g., if the first set of APIs did not handle one or more of the criteria). Once suitable properties are identified, the platform may use another API (e.g., a scheduling API) to reserve virtual tours. The platform may also use an LLM to create personalized property summaries based on the user criteria and any other user preferences known to the platform. The platform may then use another API (e.g., an email service API) to send the personalized property summaries.

"Track market trends in specific neighborhoods, compare historical price data, and generate and email investment insights to my buyers looking in the respective areas." For this example use case, the platform may use a first (set of) API(s) to gather market trends and historical price data for specific neighborhoods (e.g., from real estate database(s) or market analysis services). The platform may then use an LLM and/or analysis service qualitatively and/or quantitatively to compare the historical price data and identify trends over time. The platform may then use the LLM to generate investment insights based on the analyses of the market trends and historical price data. These insights may also be tailored to the personalized interests of different users of the platform. Finally, the platform may use another API (e.g., an email service API) to email these personalized investment insights to the users who are interested in the respective neighborhoods.

"Automate tenant background checks by fetching credit scores, rental histories, and references, then compile a report for landlord review." For this example use case, the platform may use a first API to fetch the prospective tenant's credit score from a credit bureau or financial institution. In some cases, this may require tenant approval, which the platform may obtain by requesting the user for permission to access user data. The platform may then use second API to gather rental history data from previous landlords or property management databases. Additionally, the platform may analyze reference information (e.g., names of references, letters provided by references) provided by the prospective tenant. In some cases, the platform may leverage an API (e.g., an email API, an AI-assisted telephone API, etc.) to automatically contact the references and record their responses, which may be received by the platform via the same API. The platform may then leverage an LLM to process this data (e.g., to identify potential red flags or inconsistencies). The platform may then leverage an LLM to compile all of the tenant information into a comprehensive report, which the platform may format and organized for easy review by the landlord (e.g., using a reporting API). Finally, the platform may deliver the report to the landlord through a document management or email API for review and decision making.

"Scan local regulations for property development, cross-reference with a proposed project plan, and generate a compliance checklist." For this example use case, the platform may use a first API to access and scan local regulations for property development (e.g., from a municipal database or a regulation management service). The platform may then use an LLM to identify and extract the relevant regulations pertaining to the proposed project. The platform may then access the proposed project plan through a second API (e.g., from a project management service), and use an LLM to cross-reference the identified regulations with the plan. Based on this cross-referencing, the LLM may generate a compliance checklist of the required actions to comply with the regulations. The platform may then output this checklist through another API into a compliance management system, send it to stakeholders via an email API, and/or the like.

"Evaluate feedback from property viewings, identify common concerns or praises, and suggest adjustments or renovations to increase saleability." For this example use case, the platform may use a first API to retrieve feedback from property viewings (e.g., from a real estate database or customer feedback system). The platform may then use a LLM to identify common concerns or praises from this data. The platform may optionally use a second API (e.g., a real estate market analysis service) to analyze how these concerns and praises align with current market trends and/or property values. The platform may then use an LLM to analyze all of the data to suggest potential adjustments or renovations to the property to increase saleability. The platform may then communicate these suggestions to relevant parties (e.g., property owners, real estate agents) via another API, such as a messaging or notification service.

### Retail Use Cases

"Monitor inventory levels across multiple store locations, predict restocking needs based on sales trends, and automate supply chain orders." For this example use case, the platform may use a first API (or set of APIs) to retrieve real-time inventory data from multiple store locations (e.g., through a retail inventory management service), sales trends data, and/or supply chain data. Then, the platform may use an LLM to generate and/or execute an analysis (e.g., via another API that provides data analysis services). Once the restocking needs are identified, the platform may further use the LLM to generate supply chain ordering schedules, taking into account factors like delivery times, supplier reliability, and cost. The platform may then send the order information to a supply chain management system through another API, thereby ensuring that the inventory across all stores is maintained optimally.

"Analyze customer purchase histories, predict future buying trends, and customize promotional offers for different customer segments." For this example use case, the platform may employ a first API to pull customer purchase histories from a customer database or CRM. Then, an LLM could be utilized to analyze these purchase histories and identify patterns or trends. A second API, perhaps a predictive analytics service, may be used to predict future buying trends based on the analysis from the LLM. The platform could then use the LLM to segment customers based on their purchase histories and predicted buying trends. Once the customer segments have been identified, the platform could customize promotional offers for each segment. This could be accomplished using a third API that interfaces with a marketing automation platform to deliver customized promotional offers to the different customer segments.

"Integrate online and in-store sales data, identify best-selling products, and adjust marketing strategies accordingly." For this example use case, the platform may use a first API to gather online sales data (e.g., from an e-commerce platform or online sales database) and a second API to gather in-store sales data (e.g., from an in-store point-of-sale system). Then, the platform may leverage an LLM and/or another API (e.g., a data analysis API) to process this data and identify the best-selling products. Once the best-selling products have been identified, the platform may use an LLM to generate insights on how marketing strategies might be adjusted to maximize sales of these products. In embodiments, the platform may then leverage another API (e.g., a marketing automation API) to update the company's digital marketing campaigns, email newsletters, social media posts, and other marketing channels based on these insights.

"Scan social media for mentions of the brand or products, analyze sentiment, and generate reports highlighting areas for potential brand enhancement." For this example use case, the platform may use a first API to scrape social media platforms for mentions of a brand or products (e.g., through a social media monitoring service). The platform may then use an LLM to analyze the sentiment of the mentions (and/or a second API for sentiment analysis). Based on the analysis, the platform may use an LLM to identify areas where the brand could potentially enhance its image or improve its products. The platform may then use a third API (e.g., a reporting service API) to generate reports highlighting these areas and/or another API to communicate the reports to the brand's marketing and product development teams.

"Automate the refund process by verifying purchase data, checking return conditions, processing the refund, and notifying the customer." For this example use case, the platform may use a first API to access purchase data from a database or an e-commerce service. The platform may then use an LLM to verify the purchase data (e.g., by checking for any discrepancies or potential issues). Next, the platform may use another API to retrieve information on the item and/or return conditions, and leverage an LLM to analyze the retailer's return policy, the state of the returned item, and/or data indicating the timeframe within which the return is being made. If the LLM determines the return conditions are met, the platform may use one or more APIs to process the refund, (e.g., a payment gateway API that can transfer the funds back to the customer). Finally, the platform may use an LLM to draft a notification for the customer, and then use a communication API to send the notification via email, SMS, or another suitable channel.

### Education Use Cases

"Fetch academic results of students, identify areas of weakness, and tailor additional resources or tutoring sessions to address those areas." For this example use case, the platform may use a first API to retrieve the academic results of students from a school database or a learning management system. The platform may then use an LLM to identify areas where students are struggling based on the fetched data. Once these areas of weakness have been identified, the platform may then use another API (e.g., from an educational content service) to retrieve additional resources that can aid students in their areas of weakness. If the LLM determines tutoring sessions are needed, the platform may use the LLM to generate a tutoring schedule based on the individual student's weaknesses and/or data indicating the student’s availability. The platform may then use a scheduling API to arrange for these tutoring sessions in a school scheduling system.

"Monitor classroom attendance, automatically notify parents if absenteeism exceeds a threshold, and schedule meetings with the counseling team." For this example use case, the platform may use a first API to retrieve classroom attendance data (e.g., from a school management system or database). The platform may then use an LLM to analyze the attendance data and detect any instances where absenteeism exceeds a set threshold. If the threshold is exceeded, the platform may use another API (e.g., a messaging or email service API) to automatically send notifications to the parents. The platform may use the LLM to generate a meeting schedule and/or priorities based on the severity and frequency of absenteeism, and may leverage another API to schedule the meetings with the counseling team (e.g., via a calendaring or scheduling API that interfaces with the school's meeting scheduling system).

"Automate the process of course enrollment by checking prerequisites, ensuring no schedule conflicts, and notifying students of successful enrollment." For this example use case, the platform may use one or more APIs to access student records (e.g., academic history, current schedule, etc.) and/or curriculum data indicating prerequisites for desired courses. The platform may then use an LLM to check for any potential scheduling conflicts with the student's existing timetable (e.g., using another API interfaced with an academic scheduling system). If no conflicts are identified and prerequisites are met, the platform may then use an API to finalize the course enrollment within the school’s registration system. Finally, the platform may use an LLM in conjunction with a communication API (e.g., an email service API) to automatically send a notification to the student, confirming their successful enrollment in the course.

"Analyze student feedback on courses and instructors, identify trends, and suggest curriculum adjustments or professional development for faculty." In this use case, the platform may use a first API to collect student feedback on courses and instructors (e.g., from an education management system or student feedback database). The platform may then leverage an LLM to analyze this feedback and identify emerging trends or commonalities. The platform may employ another API (e.g., a data analysis service API) to further analyze and detect patterns in the feedback data. Based on these trends and patterns, the LLM may suggest possible curriculum adjustments or areas of professional development for faculty. The platform may then use another API (e.g., a curriculum management API or professional development scheduling API) to implement these suggestions and schedule necessary training for the faculty.

"Track library book checkouts, send reminders for due dates, automate late fee calculations, and suggest related books for future reading." For this use case, the platform may use a first API to periodically access library book checkout data (e.g., from a library management system or database). The platform may then leverage another API (e.g., a messaging service API) to send automated reminders to borrowers as the due dates approach. The platform may also use an LLM and/or another API (such as a financial calculation API) to automate the calculation of late fees, if any, based on the overdue duration. Finally, the platform may use an LLM to analyze the borrower's reading preferences and suggest related books for future reading. This recommendation may be based on the books checked out by the borrower, data from a book recommendation API, or both. The platform may then use another messaging service API to send these book recommendations to the borrower.

### Typical End User Use Cases

Stay-at-Home Parent: "Organize a list of family-friendly movies releasing this month, cross-reference with kids' preferences, and schedule a movie night, sending out invites to family members." In this use case, the platform may use a first API to gather information about family-friendly movies releasing in the current month (e.g., from a movie database or related service). Then the platform may use stored preferences data for related users (e.g., user profiles for the kids) or other data it may obtain about the kids' preferences. The platform may then use an LLM to analyze which of the movies match the preferences and then schedule a suitable movie night based on the family's availability, which can be retrieved from a calendaring API. Finally, the platform may use the calendaring API or another API (e.g., an email service API) to send out invites for the movie night to all family members, including details such as the chosen movie and the scheduled date and time.

Teenager: "Track the top trending songs across multiple genres, create a dynamic playlist, and set up alerts for new releases from favorite artists." In this use case, the platform may leverage a first API to gather data on top trending songs across various genres (e.g., from a music streaming service or music chart database), then use a music streaming API to create a dynamic playlist. The platform may infer favorite artist data using an LLM and/or reference user profile information to determine favorite artists. The platform may then configure periodical API calls to re-check for new trending songs by favorite artists and send out alerts when new releases from these favorite artists. When a new song from a favorite artist is released, the platform may use an API (e.g., a notification service API) to send an alert to the teenager. Additionally, the LLM may add the new release to the dynamic playlist automatically.

Hobbyist Photographer: "Scan online forums for upcoming photography workshops or webinars, register for relevant ones, and mark them in the calendar with reminders." In this use case, the platform may a first (set of) API(s) (e.g., a web scraping API or forum API) to search online forums for information on upcoming photography workshops or webinars. It may then use an LLM to identify the ones that are relevant (e.g., based on profile data indicating the user's preferences, interests, or past attendance). Once relevant workshops or webinars have been identified, the platform may use another API (such as a workshop registration API) to automatically register the user for these events. Following successful registration, the platform may use the LLM to set up calendar events for each workshop or webinar, including details like date, time, and other pertinent information. The platform may then add the calendar events to the user’s calendar via a calendar API.

College Student: "Compile a list of recommended reading materials for this semester's courses, check availability in online stores, and reserve or purchase the top three based on reviews." In this use case, the platform may use a first API to interface with the college's course management system and gather information about the student's current semester courses. Then, the platform may leverage an LLM to determine recommended reading materials based on the subject of the course and potentially prioritize the books based on their relevance to the courses. Next, the platform may use a second API to check the availability of these books in various online stores (e.g., Amazon, Barnes & Noble, etc.) and obtain review data. The LLM may then analyze the reviews and select the top three books. Finally, the platform may use another API to reserve or purchase these books on behalf of the student.

Fitness Enthusiast: "Monitor local gyms or studios for new classes or offers, cross-reference with personal schedule, and book a slot for the most convenient time." In this use case, the platform may use one or more APIs to gather data from local gyms or studios about their new classes and offers (e.g., through a web scraper API, scheduling API, or similar service). The platform may optionally use an LLM to filter this data based on any user's preference data stored by the platform. The platform may then use a second API to access the user's personal schedule (e.g., a calendar or personal schedule management API). The platform may then analyze the gym or studio schedules against the user's personal schedule to identify the most convenient time slots. Once these slots are identified, the platform may then use a third API (e.g., a booking API provided by the gym or studio, or a general AI-assisted booking API) to automatically book a slot for the user at the most convenient time.

Retiree: "Track upcoming community events or senior activities, suggest ones that align with personal interests, and automate RSVPs or ticket bookings." In this use case, the platform may use a first API to gather information on upcoming community events or senior activities (e.g., through a local event database API, web scraper API, etc.). The platform may then use an LLM to analyze the data to identify events that align with the personal interests of the retiree (e.g., according to a user profile) generate matching suggestions for the retiree. In embodiments, the platform may then automate the RSVP or ticket booking process (e.g., via an event booking service API).

Gardening Aficionado: "Identify best planting times based on local weather forecasts, create a gardening schedule, and set up reminders for watering or fertilizing." In this use case, the platform may use one or more APIs to gather local weather forecast data (e.g., from a weather service) and detailed plant information (e.g., from a web search). The platform may then use an LLM to analyze this data to identify the best times for planting various types of plants in the local area and to create a personalized gardening schedule (e.g., including water and fertilizing times) based on these optimal planting times, taking into account the specific needs and growth cycles of the plants involved. The platform may then use a reminder or scheduling API to create and send reminders to the user at the appropriate times.

Young Adult: "Scan online stores for sales on fashion brands, create a wish list, and set up price alerts for chosen items." In this use case, the platform may use one or more APIs to scan various online stores (e.g., a web scraping API or APIs provided by the online stores themselves) for sales on desired fashion brands. The platform may then use an LLM to process the data to identify sales and compare prices across different platforms. The LLM may further create a wish list based on the user's preferences (e.g., previous searches and/or other information stored in a user profile). The platform may set up periodic price checks and, if the price of an item drops to a set threshold, the platform may send a notification to the user (e.g., via an email API or a mobile push notification API) indicating they may make a purchase at their desired price point.

Book Lover: "Fetch the latest releases in chosen genres, cross-reference with favorite authors, and send a monthly reading list with purchase or borrowing options." In this use case, the platform may determine a user’s preferred genres and authors based on stored user profile information, then use a first API to access information about newly released books (e.g., from a book website or other ecommerce platform) in the preferred genres. Additionally or alternatively, the user preference data may be retrieved from a third-party website (e.g., a book review platform). The platform may then use the LLM to generate a monthly reading list of new books tailored to the user's preferences. The platform may further provide purchase or borrowing options for each book on the list, (e.g., after fetching data from a variety of sources such as online retailers, library systems, or secondhand book platforms). Finally, the platform may use an API to send the reading list with recommendations to the user, for instance via an email service or mobile app notification system.

Travel Enthusiast: "Monitor flight or hotel deals for a chosen destination, cross-reference with personal vacation dates, and suggest the best travel itinerary." In this use case, the platform may use one or more APIs to gather travel deal data from various sources (e.g., airline databases, hotel booking services, etc.). The platform may use an LLM to identify the best deals based on criteria such as cost, location, and/or quality, which may be determined or inferred based on user profile data stored by the platform and/or user input. The platform may use a second API to access the user's personal vacation dates (e.g., from a personal calendar service or employee time-off database) and use an LLM to filter the deals based on these dates. The platform may then use the LLM to suggest the most optimal travel itinerary based on the user's vacation dates and the identified deals. The platform may then send the proposed itinerary to the user through a third API, such as an email service or a travel itinerary app.

### Multimedia Knowledge Base Application

In embodiments, the platform may be configured to support a multimedia knowledge base application. A multimedia knowledge base application as described herein may allow users to retrieve media files and/or components of media files based on requests submitted to a large language model or other generative AI model (e.g., via a chatbot). For example, users may ask a chatbot questions, and the chatbot may respond by identifying relevant media files and/or excerpts of media files to provide an answer or partial answer. In some scenarios, the multimedia knowledge base application may stitch, assemble, or otherwise curate a response comprised of respective excerpts from multiple media files, such that the response to the user includes content from the respective excerpts. In embodiments, the multimedia knowledge base application and the API-connected chat application described above may be separate applications. Additionally or alternatively, these two applications may be combined into a single application (on platform 100) that can provide an interface capable of both 1) accessing data from various API endpoints as described above and 2) accessing data from various media files that may have been pre-processed by the application, as described below. Accordingly, it should be understood that the multimedia knowledge base application may be a standalone application or may be integrated into the API-connected chat application.

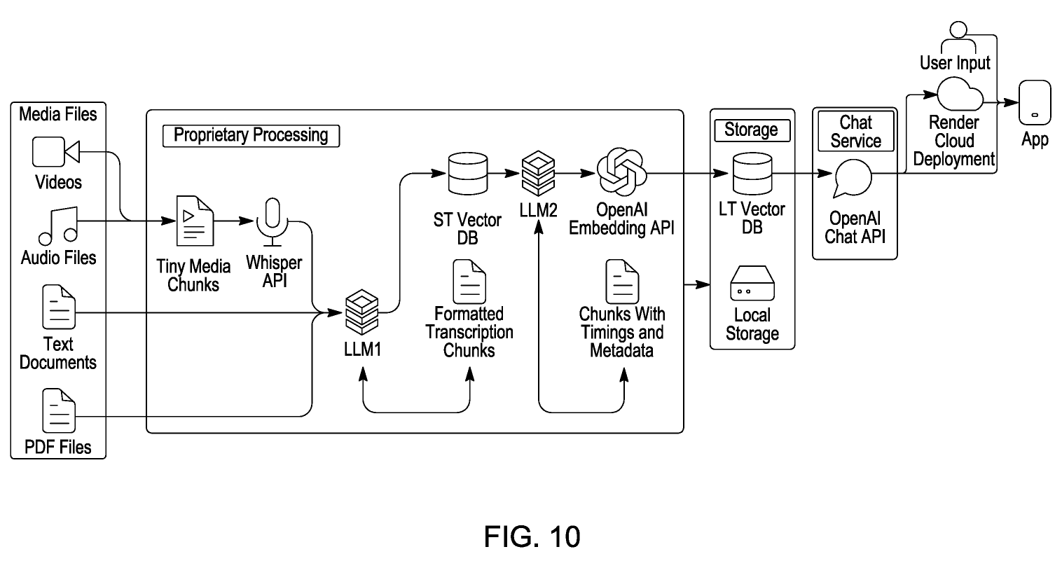

As shown in FIG. 10, the multimedia knowledge base application may include a proprietary processing service/engine 148 that is configured to ingest various types of media files and process them to aid in retrieval. The media files may include videos, audio files, text documents, PDF files, and other types of media files. The application's processing engine processes these files into chunks that can be analyzed and used to provide relevant portions of the media files to users of the application in response to user requests or queries. The application may provide a chat interface that allows users to view and/or engage with the media files through the chat interface.

In embodiments, for video or audio files, the processing engine may break down the files into “tiny media chunks,” which may be chunks of the media files that may cover a few seconds up to a few minutes. In some cases, the processing engine may separate the content into chunks of a configurable size (e.g., 30 seconds, one minute, etc.). Additionally or alternatively, the processing engine may create chunks based on audio indicators such as breaks in speech or other contextual information or metadata from the media file (e.g., file length), as well as adjustable minimum or maximum chunk sizes. The application may then process the media chunks using voice-to-text transcription software, which may be hosted locally or remotely (e.g., via the WHISPER API or other voice-to-text APIs). In some embodiments, the voice-to-text transcription software may include features for identifying and labeling different speakers using automated and/or manual processes. In these embodiments, the transcript may include the names (or pseudonymous identities) of different speakers.

The processing engine may further generate timing information for each chunk (e.g., starting and ending timestamps). In some cases, the timing information may include timing information (e.g., timestamps) for each new speaker, for each sentence, for each word, and/or the like, in order to provide more fine-grained retrievability. Additionally or alternatively, the processing engine may generate chunks of other types of files. For example, it may chunk text files into sentences or paragraphs, tabular files into rows or columns, etc., and provide similar information for retrieving the relevant portion (e.g., page number, row number, etc.).

In some embodiments, the processing engine may also process video files to generate “visual transcripts” that may indicate, for example, what items are being shown in the video at specific times. For example, a visual transcript may indicate that a certain person/item/entity is shown on screen between a first timestamp and a second timestamp. To generate the visual transcripts, the processing engine may leverage AI-based image recognition models. The visual transcripts may be textual and therefore may be used for later media chunk retrieval in a similar way as the audio transcripts.

After generating textual transcriptions (e.g., audio and/or visual transcripts) for the video and audio chunks and/or chunks of other types of files, the application may send the chunk data (including the chunk transcriptions and/or chunks of text from text documents or PDF files) and relevant metadata (e.g., timing data, etc.) to an LLM (shown as LLM1 in FIG. 2), which may generate formatted transcription chunks for the different types of media files. The formatted transcription chunks may include transcription and metadata information in a standardized format/schema. For example, the application may prompt the LLM with instructions for formatting the transcriptions and metadata into the standard format/schema. In embodiments, the instructions may include examples of the format/schema, which may allow the LLM to process the input data into formatted output data. These formatted transcription chunks may be stored in a short-term vector database. In embodiments, the LLM may be hosted locally (e.g., using an open source LLM) or remotely at a third party LLM service (e.g., a cloud-based LLM model).

The application may also use the LLM to process the data from the short-term vector database to generate additional metadata (shown as LLM2 in FIG. 2, meaning a second processing step using the same LLM or a different LLM). The LLM may generate metadata such as summaries of the transcription as a whole, summaries of individual transcription chunks, topics or key words referenced in the chunk transcript, and/or the like. The LLM may output the generated metadata together with the formatted timings and other metadata information for each different chunk of the media file in the standardized schema/format described above. For example, after the second LLM processing step, the metadata for each media chunk may include a summary of the transcription of the media chunk and/or a summary of the media file as a whole, topics or keywords for the media chunk and/or the media file as a whole, timing information, other media file metadata, etc.

The application may then send the text chunks and/or transcriptions, timings, and/or other metadata (including generated metadata, summaries, etc.) to an embeddings model, which again may be hosted locally or remotely (e.g., via embeddings provided by a third-party service). The embeddings model may generate a vectorized form of any data it receives as an input. The vectorized data may be stored and efficiently retrieved from a long-term vector database via a vector similarity search.

Accordingly, the output of the proprietary processing may include the various media files/chunks (including transcriptions thereof) and associated timings and other metadata, which may be stored in local storage, as well as vectorized forms of the media chunks, transcriptions, timing information, metadata, etc. which may be stored in a long-term vector database for later retrieval (e.g., at runtime).

The application further includes a chat services component that allows users to interact with an LLM-based chatbot or otherwise submit requests to an LLM (e.g., via a browser-based application, mobile application, or other application that may be accessible via a user device). In embodiments, the chat service may find and retrieve different media file content and related metadata (e.g., timing data for linking to specific pieces of the content) based on user requests or other contextual indicators that additional information would be useful (e.g., if the LLM is trained to automatically fetch evidence to support an argument, answer a question, etc.). The chat application may render the media files or relevant chunks thereof via the application and/or provide links to the media content.

In embodiments, the application may find relevant media content (or chunks thereof) using a vector-based similarity comparison to find relevant information from the long-term vector database based on user queries or other pieces of a conversation with a chatbot. For example, the application may identify and extract a user query from a conversation and/or prompt the LLM to generate a query based on a context of the conversation. Additionally or alternatively, the LLM may generate its own query (e.g., if it is trained to access supporting materials when relevant). The application may then vectorize the query and search the long-term vector database by submitting the vectorized query to a cosine similarity function (or some other measure of vector similarity), where the cosine similarity function finds relevant media files or media chunks based on a similarity of the vectorized query to vectorized content in the database.

In embodiments, the application may perform a similarity search and analyze whether each media chunk is relevant based on the transcript (or other text content) as well as a summary of the chunk and/or a summary of the media file as a whole. For example, a user may ask for videos referencing a certain topic (e.g., COVID-19), and the storage database may contain videos where the topic was discussed in detail for some or all of the video, as well as other videos where the topic was briefly mentioned but not discussed in detail. The application may find more relevant videos by analyzing vector similarity of the user query (which may reference COVID-19, coronavirus, or other similar terms that may generate similar vectors) to not only the transcript (which may include references to the same or similar terms), but also the various summaries of the chunk or media file as a whole (which will be more likely to reference the terms if they were topics that were discussed in detail or at length). Accordingly, the application may use summary and/or other generated metadata to find better and/or more relevant media chunks that discuss topics in more detail.

After finding a relevant media chunk, the application may then retrieve the relevant media file or media chunk and provide the relevant media file or media chunk to the user via the application. In some cases, the application may present an entire media file within a multimedia user interface 118 (e.g., a video/audio file in an embedded playback window, a PDF in an embedded PDF reader, etc.) and begin playback of the audio/video file at a relevant timestamp based on the most similar media chunk (or turn to a relevant page of the PDF or other text file based on a most similar chunk of the PDF, etc.). In other words, the application may automatically “fast forward” to the relevant excerpt of the media file. Additionally or alternatively, the application may present only the relevant media chunk without providing the entire media file. In some embodiments, instead of or in addition to presenting the media file embedded within the user interface, the application may instead present a link to the media file and/or chunk. Additionally or alternatively, the application may provide the audio or visual transcript of the media file/chunk to the user. The application thereby provides an interactive chatbot interface that allows users to engage with the chatbot and access media file content as it becomes relevant in a conversation.

In embodiments, the application may find several relevant media chunks and provide each of the media chunks and/or transcriptions of the media chunks to the user. For example, it may provide the various chunks and/or transcripts of chunks as separate embedded items (or links to items) and/or may combine the media chunks together into a single embedded file (e.g., such that a user may listen to or watch only relevant portions of a larger audio/video file, read through only relevant portions of a text document, etc.).

In embodiments, a user may continue to engage with the relevant media chunk(s) and/or transcripts thereof using the LLM chat application. For example, if the application presents (or links to) one or more relevant excerpts of audio/video files, the user may ask the chatbot to summarize the excerpt(s), may ask follow-up questions based on the information in the excerpts, and/or the like. In other words, the LLM allows a user to engage more deeply with and/or further process the retrieved media chunks and/or transcripts thereof. Additionally or alternatively, if the knowledge base application is integrated with the API-connected chat application described above, the user may request that the chat application use the processed information to call one or more APIs, for example to email the relevant information via an API-connected email service, store the relevant information via an API-connected storage service, process a retrieved video (or chunk thereof) via an API-connected video editing or processing service, and/or the like.

In embodiments, the multimedia knowledge base application may leverage any of the relevant technologies described above for the API-connected chat application, may be efficiently deployed via a cloud platform/system, and/or otherwise may be architected and/or deployed as described elsewhere herein.

### Conclusion

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor, or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the processor may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client, and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers, and the like. Furthermore, the elements depicted in the flow chart and block diagrams, or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure, and combinations thereof, may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the various embodiments shown and described in detail, various modifications and improvements thereon will become readily apparent to those skilled in the art. Accordingly, the spirit and scope of the disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

What is claimed is:

1. A method of using an API to respond to a user input, the method comprising:
searching, by an API orchestration platform, for at least one API endpoint for performing a task;
retrieving, by the API orchestration platform, API information for the at least one API endpoint responsive to the searching;
causing, by the API orchestration platform, an artificial intelligence (AI) model to analyze the API information to generate structured API contextual information for the at least one API endpoint;
storing, by the API orchestration platform, the structured API contextual information;
receiving, by the API orchestration platform, the user input from a user device;
determining, by the API orchestration platform, a set of API endpoints that match the user input based on corresponding structured API contextual information for each of the set of API endpoints;
generating, by the API orchestration platform, a set of API calls using the corresponding structured API contextual information;
transmitting, by the API orchestration platform, the set of API calls to the set of API endpoints;
receiving, by the API orchestration platform, a set of responses from the set of API endpoints; and
transmitting, by the API orchestration platform, a response to the user input, wherein the response is based on the set of responses received from the set of API endpoints.

2. The method of claim 1, wherein the API information comprises at least one API documentation page, wherein the AI model analyzes the at least one API documentation page to generate structured API contextual information based on the at least one API documentation page.

3. The method of claim 2, wherein the structured API contextual information comprises one or more of an intent field, a resource field, a parameters field, or a modifier field.

4. The method of claim 3, wherein the AI model is a language model, wherein the platform causes the language model to analyze the at least one API documentation page by transmitting a prompt to the language model, wherein the prompt includes first text derived from the at least one API documentation page and second text indicating how to generate values for the one or more of the intent field, the resource field, the parameters field, or the modifier field.

5. The method of claim 1, wherein the API information comprises a plurality of responses received from the at least one API endpoint, wherein retrieving the API information comprises generating a plurality of test API calls and transmitting the plurality of test API calls to the at least one API endpoint, wherein the plurality of test API comprise different parameters.

6. The method of claim 5, wherein the AI model is a language model, wherein the platform causes the language model to analyze the plurality of responses by transmitting a prompt to the language model, wherein the prompt includes first text derived from the plurality of responses and second text indicating how to generate various fields of the structured API contextual information.

7. The method of claim 1, further comprising:
tokenizing, by the API orchestration platform, at least one field of the structured API contextual information;
generating, by the API orchestration platform, embeddings for the tokenized at least one field of the structured API contextual information; and
storing, by the API orchestration platform, the generated embeddings as part of the structured API contextual information,
wherein determining the set of API endpoints that match the user input is based on the generated embeddings.

8. The method of claim 1, where causing the AI model to analyze the API information to generate structured API contextual information for the at least one API endpoint further comprises:
generating a plurality of key words characterizing the at least one API endpoint,
wherein determining the set of API endpoints that match the user input is based on the plurality of key words.

9. The method of claim 1, wherein retrieving, by the API orchestration platform, the API information for the at least one API endpoint responsive to the searching comprises:
crawling a plurality of links within an API documentation root page to access a plurality of API documentation sub-pages; and
retrieving respective content from each of the API documentation root page and the plurality of API documentation sub-pages, wherein the content corresponds to a set of API commands,
wherein the structured API contextual information for the at least one API endpoint comprises structured API contextual information for each of the set of API commands.

10. The method of claim 1, wherein the retrieved API information includes a content hash value, the method further comprising:
prior to causing the AI model to analyze the API information to generate structured API contextual information for the at least one API endpoint, determining that the content hash value was not previously stored by the API orchestration platform.

11. The method of claim 10, wherein the content hash value is an ETag from an HTTP response header.

12. The method of claim 1, wherein the set of API calls are sequential such that an output of a first API endpoint of the set of API endpoints is provided as an input to a second API endpoint of the set of API endpoints.

13. The method of claim 1, further comprising causing, by the API orchestration platform, an AI model to process one or more of inputs or outputs of the set of API endpoints, wherein the response to the user input is based on processed output of the AI model.

14. The method of claim 1, wherein determining the set of API endpoints that match the user input based on corresponding structured API contextual information for each of the set of API endpoints comprises:
determining a matching API recipe that specifies the set of API endpoints, wherein the API recipe is linked to the structured API contextual information for each of the set of API endpoints.

15. The method of claim 14, wherein the API recipe specifies an order of operations of the set of API endpoints.

16. The method of claim 14, wherein the API recipe specifies that an output of a first API endpoint of the set of API endpoints is provided as input to a second API endpoint of the set of API endpoints.

17. The method of claim 14, wherein the API recipe specifies that an output of a first API endpoint of the set of API endpoints is provided as input to a language model and that an output of the language model is provided as input to a second API endpoint of the set of API endpoints.

18. The method of claim 14, wherein the API recipe is generated prior to receiving the user input.

19. The method of claim 14, wherein the API recipe was generated by the API-enable chat platform in response to a different user task query from a different user.

20. The method of claim 14, further comprising generating, by the API-enable chat platform, the API recipe in response to the user input.

21. The method of claim 1, wherein determining, by the API orchestration platform, the set of API endpoints that match the user input based on corresponding structured API contextual information for each of the set of API endpoints comprises:
causing, by the API orchestration platform, the AI model to process the user input to identify a plurality of tasks within the user input and to generate data for each task based on a command schema;
causing, by the API orchestration platform, an embeddings model to generate a plurality of embeddings based on the data for each task; and
comparing, by the API orchestration platform, the plurality of embeddings to the structured API contextual information, wherein the determining of the set of API endpoints that match the user input is based on a comparison similarity.

22. The method of claim 21, wherein the command schema comprises at least an intent value and one or more parameter values.

23. The method of claim 21, wherein the comparing comprises performing a vector comparison of the plurality of embeddings to embeddings within the structured API contextual information.

24. The method of claim 23, wherein the comparison similarity is a measure of vector similarity.

25. The method of claim 23, wherein the embeddings within the structure API contextual information are structured according to the command schema.

26. The method of claim 1, further comprising:
storing a plurality of user inputs and corresponding responses to the plurality of user inputs; and
fine-tuning the AI model based on the plurality of user inputs and corresponding responses to the plurality of user inputs.

27. The method of claim 1, further comprising:
storing a plurality of API endpoint responses over time that correspond to a particular API endpoint; and
iteratively refining structured API contextual information corresponding to the particular API endpoint based on the plurality of API endpoint responses stored over time.

28. The method of claim 27, wherein iteratively refining the structured API contextual information includes adding optional API parameters to the structured API contextual information.

29. The method of claim 27, wherein iteratively refining the structured API contextual information includes increasing a confidence level data value within the structured API contextual information as additional information is added to the structured API contextual information.

30. The method of claim 29, wherein determining the set of API endpoints that match the user input is based at least in part on respective confidence level data values for the set of API endpoints.

31. The method of claim 1, wherein determining the set of API endpoints that match the user input is based at least in part on a user profile associated with the user.

32. The method of claim 31, wherein the user profile indicates at least one preferred API provider, wherein determining the set of API endpoints that match the user input comprises selecting the at least one preferred API provider.

33. The method of claim 32, wherein the at least one preferred API provider comprises a preferred communication API.

34. The method of claim 32, wherein the at least one preferred API provider comprises a preferred social media API.

35. The method of claim 32, wherein the at least one preferred API provider comprises a preferred calendaring API.

36. The method of claim 32, wherein the at least one preferred API provider comprises a preferred travel booking API.

37. The method of claim 32, wherein the at least one preferred API provider comprises a preferred data source API.

38. The method of claim 32, wherein the at least one preferred API provider comprises a preferred data analysis API.

39. The method of claim 31, wherein the user profile comprises API login credentials, wherein at least one API call of the set of API calls includes the API login credentials.

40. The method of claim 31, wherein the user profile indicates a ranked list of API preferences, wherein determining the set of API endpoints that match the user input comprises selecting a higher ranked API endpoint based on the ranked list of API preferences.
